(19) United States
(12) Patent Application Publication
(10) Pub. No.: US 2017/0085839 A1
(43) Pub. Date: Mar. 23, 2017

(54) METHOD AND SYSTEM FOR PRIVACY PRESERVING LAVATORY MONITORING

(71) Applicant: Dan Valdhorn, Haifa (IL)

(72) Inventor: Dan Valdhorn, Haifa (IL)

(21) Appl. No.: 15/266,491

(22) Filed: Sep. 15, 2016

Related U.S. Application Data
(60) Provisional application No. 62/219,672, filed on Sep. 17, 2015.
(60) Provisional application No. 62/276,322, filed on Jan. 8, 2016.
(60) Provisional application No. 62/286,339, filed on Jan. 23, 2016.

(51) Int. Cl. H04N 7/18; G06K 9/62; G06K 9/00

(52) U.S. Cl. CPC H04N 7/183; G06K 9/00771; G06K 9/00362; G06K 9/6269; G06K 2009/00322; G06K 2209/09; G06K 9/00228

(57) ABSTRACT

Privacy preserving methods and apparatuses for capturing and processing optical information are provided. Optical information may be captured by a privacy preserving optical sensor. The optical information may be processed, analyzed, and monitored. Based on the optical information, information and indications may be provided. Such methods and apparatuses may be used in environments where privacy may be a concern, including in a lavatory environment.

### CROSS REFERENCES TO RELATED APPLICATIONS

This application claims the benefit of priority of U.S. Provisional Patent Application No. 62/219,672, filed on Sep. 17, 2015, which is incorporated herein by reference in its entirety.

This application claims the benefit of priority of U.S. Provisional Patent Application No. 62/276,322, filed on Jan. 8, 2016, which is incorporated herein by reference in its entirety.

This application claims the benefit of priority of U.S. Provisional Patent Application No. 62/286,339, filed on Jan. 23, 2016, which is incorporated herein by reference in its entirety.

### BACKGROUND

Technological Field

The invention generally relates to methods and systems for capturing and processing optical information. More particularly, this invention relates to methods and systems for capturing and processing optical information from an environment of a lavatory.

Background Information

Optical sensors, including image sensors, are now part of numerous devices, from security systems to mobile phones. As a result, the availability of optical information, including images and videos, produced by these devices is increasing. The increasing prevalence of image sensors and the optical information they generate may raise concerns regarding privacy.

### SUMMARY

In some embodiments, a privacy preserving optical sensor is provided. In some embodiments, a privacy preserving optical sensor implemented using one or more image sensors and one or more masks is provided.

In some embodiments, a method and an apparatus for receiving and storing optical information captured using a privacy preserving optical sensor is provided. The optical information may be processed, analyzed, and/or monitored. Information and indications may be provided.

In some embodiments, a method and a system for capturing optical information from an environment of a lavatory is provided. The optical information may be processed, analyzed, and/or monitored. Information and indications may be provided.

In some embodiments, optical information may be captured from an environment; an estimated number of people present in the environment may be obtained; and information associated with the estimated number of people present may be provided.

In some embodiments, optical information may be captured from an environment; the optical information may be monitored; and indications may be provided. For example, the indications may be provided: when a person is present in the environment; when an object is present in the environment; when an event occurs in the environment; when the number of people in the environment equals or exceeds a maximal threshold; when no person is present in the environment; when smoke is detected in the environment; when fire is detected in the environment; when a distress condition is detected in the environment; when a sexual harassment is detected in the environment; and so forth.

In some embodiments, optical information may be captured from an environment; the optical information may be monitored; and an indication that an object is present and no person is present, after the object was not present and no person was present, may be provided.

In some embodiments, optical information may be captured from an environment; the optical information may be monitored; and an indication that an object is not present and no person is present, after the object was present and no person was present, may be provided.

In some embodiments, optical information may be captured from an environment of a lavatory; the optical information may be monitored; and an indication may be provided when the lavatory requires maintenance.

### BRIEF DESCRIPTION OF THE DRAWINGS

FIGS. 1A and 1B are block diagrams illustrating some possible implementations of an imaging apparatus.

FIGS. 2A, 2B, 2C, 2D, 2E and 2F are block diagrams illustrating some possible implementations of an imaging apparatus.

FIGS. 3A, 3B and 3C are schematic illustrations of some examples of a mask.

FIGS. 3D and 3E are schematic illustrations of some examples of a portion of a mask.

FIG. 4A is a schematic illustration of an example of a portion of a color filter combined with a mask.

FIG. 4B is a schematic illustration of an example of a portion of a micro lens array combined with a mask.

FIG. 4C is a schematic illustration of an example of a portion of a mask directly formed on an image sensor.

FIG. 4D is a schematic illustration of an example of a portion of an image sensor with sparse pixels.

FIG. 5 is a block diagram illustration of an example of a possible implementation of a computing apparatus.

FIG. 6 is a block diagram illustration of an example of a possible implementation of a monitoring system.

FIG. 7 illustrates an example of a process for providing indications.

FIG. 8 illustrates an example of a process for providing indications.

FIG. 9 illustrates an example of a process for providing information.

FIG. 10 illustrates an example of a process for providing indications.

FIG. 11 illustrates an example of a process for providing indications.

FIG. 12 illustrates an example of a process for providing indications.

FIG. 13 illustrates an example of a process for providing indications.

FIG. 14 illustrates an example of a process for providing indications.

FIG. 15 illustrates an example of a process for providing indications.

FIG. 16 illustrates an example of a process for providing indications.

FIG. 17 illustrates an example of a process for providing indications.

FIGS. 18A and 18B are schematic illustrations of some examples of an environment.

FIGS. 19A, 19B, 19C and 19D are schematic illustrations of some examples of an environment.

### DESCRIPTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “receiving”, or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a core within a processor, any other electronic computing device, or any combination of the above.

The operations in accordance with the teachings herein may be performed by a computer specially constructed or programmed to perform the described functions.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus the appearance of the phrase “one case”, “some cases”, “other cases” or variants thereof does not necessarily refer to the same embodiment(s). As used herein, the term “and/or” includes any and all combinations of one or more of the associated listed items.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

As used herein, the term “lavatory” is to be broadly interpreted to include: any room, space, stall and/or compartment with at least one of: toilet, flush toilet, pit toilet, squat toilet, urinal, toilet stall, and so on; any room, space, or compartment with conveniences for washing; the total enclosure of a toilet room; public toilet; latrine; aircraft lavatory; shower room; public showers; bathroom; and so forth. The following terms may be used as synonymous terms with “lavatory”: toilet room; restroom; washroom; bathroom; shower room; water closet; WC; and so forth.

The term “image sensor” is recognized by those skilled in the art and refers to any device configured to capture images, a sequence of images, videos, and so forth. This includes sensors that convert optical input into images, where optical input can be visible light (like in a camera), radio waves, microwaves, terahertz waves, ultraviolet light, infrared light, x-rays, gamma rays, and/or any other light spectrum. Examples of image sensor technologies include: CCD, CMOS, NMOS, and so forth.

The term “optical sensor” is recognized by those skilled in the art and refers to any device configured to capture optical input. Without being limited, this includes sensors that convert optical input into digital signals, where optical input can be visible light, radio waves, microwaves, terahertz waves, ultraviolet light, infrared light, x-rays, gamma rays, and/or any other light spectrum. One particular example of an optical sensor is an image sensor.

As used herein, the term “optical information” refers to any information associated with an optical input. Without being limited, this includes information captured by image sensors, optical sensors, and so forth.

As used herein, the term “privacy preserving” refers to a characteristic of any device, apparatus, system, method, software, implementation, and so forth, which, while outputting images or image information, does not output visually recognizable images, visually recognizable sequence of images, and/or visually recognizable videos of the environment. Without being limited, some devices, apparatuses, systems, methods, software, implementations, and so forth, may be privacy preserving under some configurations and/or settings, while not being privacy preserving under other configurations and/or settings.

As used herein, the term “privacy preserving optical sensor” refers to an optical sensor that does not output visually recognizable images, visually recognizable sequence of images, and/or visually recognizable videos of the environment. Without being limited, some optical sensors may be privacy preserving under some settings, while not being privacy preserving under other settings.

As used herein, the term “permanent privacy preserving optical sensor” refers to a privacy preserving optical sensor that cannot be converted into an optical sensor that is not a privacy preserving optical sensor without physical modification.

In embodiments of the presently disclosed subject matter, one or more stages illustrated in the figures may be executed in a different order and/or one or more groups of stages may be executed simultaneously and vice versa. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings. described.

The drawings in this document may not be to any scale. Different figures may use different scales and different scales can be used even within the same drawing, for example different scales for different views of the same object or different scales for the two adjacent objects.

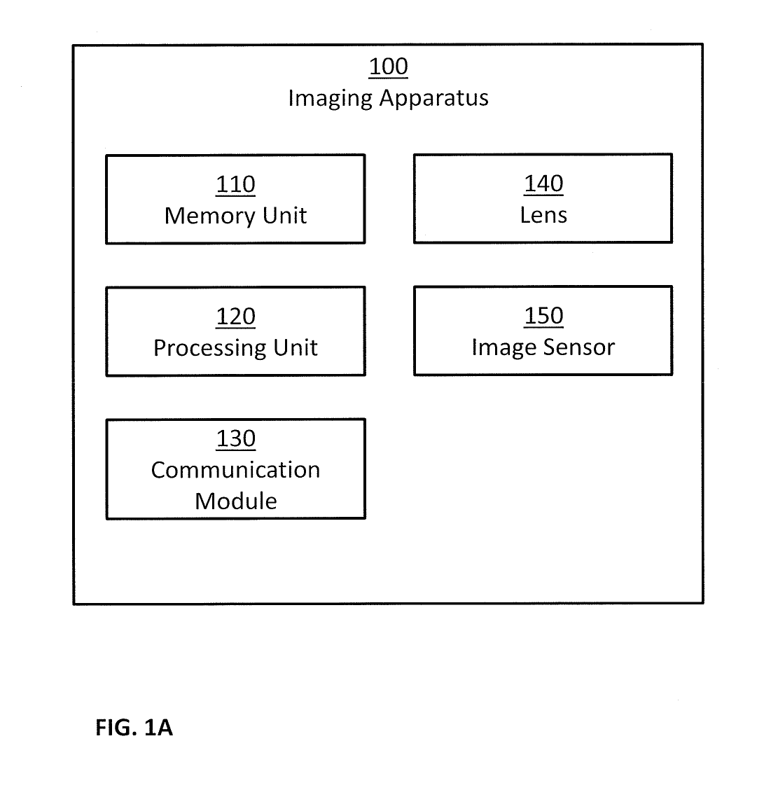

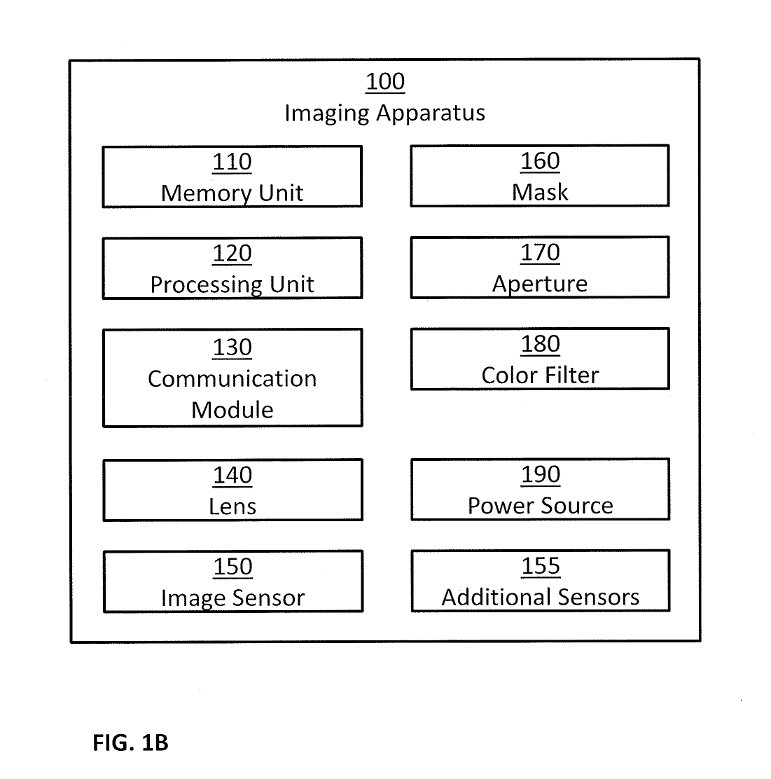

FIG. 1A is a block diagram illustration of an example of a possible implementation of an imaging apparatus 100. In this example, the imaging apparatus 100 comprises: one or more memory units 110; one or more processing units 120; one or more communication modules 130; one or more lenses 140; and one or more image sensors 150. In some implementations, imaging apparatus 100 may comprise additional components, while some components listed above may be excluded.

FIG. 1B is a block diagram illustration of an example of a possible implementation of an imaging apparatus 100. In this example, the imaging apparatus 100 comprises: one or more memory units 110; one or more processing units 120; one or more communication modules 130; one or more lenses 140; one or more image sensors 150; one or more additional sensors 155; one or more masks 160; one or more apertures 170; one or more color filters 180; and one or more power sources 190. In some implementations, imaging apparatus 100 may comprise additional components, while some components listed above may be excluded. For example, in some implementations imaging apparatus 100 may also comprise one or more lenses with embedded masks 141, while the one or more lenses 140 and the one or more masks 160 may be excluded. As another example, in some implementations imaging apparatus 100 may also comprise one or more color filters combined with masks 181, while the one or more color filters 180 and the one or more masks 160 may be excluded. As an additional example, in some implementations imaging apparatus 100 may also comprise one or more micro lens arrays combined with masks 420, while the one or more masks 160 may be excluded. As another example, masks may be directly formed on an image sensor, therefore combining the one or more image sensors 150 and the one or more masks 160 into one or more masks directly formed on image sensors 430. As another example, in some implementations imaging apparatus 100 may also comprise one or more image sensors with sparse pixels 440, while the one or more masks 160 may be excluded. In another example, in some implementations the one or more additional sensors 155 may be excluded from imaging apparatus 100.

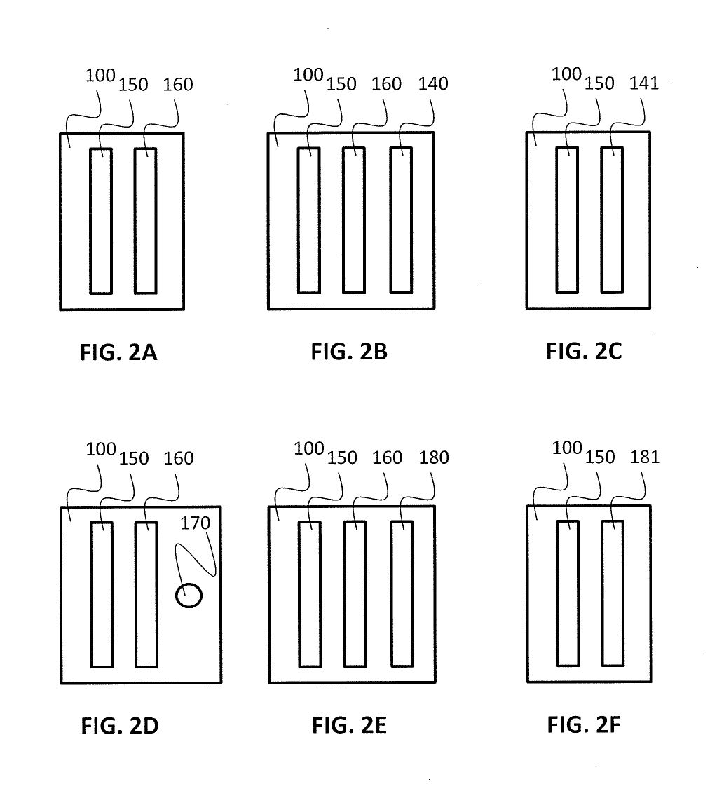

FIG. 2A is a block diagram illustrating possible implementation of an imaging apparatus 100. In this example, the imaging apparatus 100 comprises: one or more image sensors 150; and one or more masks 160. We note that in some implementations imaging apparatus 100 may comprise additional components, while some components listed above may be excluded.

FIG. 2B is a block diagram illustrating possible implementation of an imaging apparatus 100. In this example, the imaging apparatus 100 comprises: one or more image sensors 150; one or more masks 160; and one or more lenses 140. We note that in some implementations imaging apparatus 100 may comprise additional components, while some components listed above may be excluded.

FIG. 2C is a block diagram illustrating possible implementation of an imaging apparatus 100. In this example, the imaging apparatus 100 comprises: one or more image sensors 150; and one or more lenses with embedded masks 141. We note that in some implementations imaging apparatus 100 may comprise additional components, while some components listed above may be excluded.

FIG. 2D is a block diagram illustrating possible implementation of an imaging apparatus 100. In this example, the imaging apparatus 100 comprises: one or more image sensors 150; one or more masks 160; and one or more apertures 170. We note that in some implementations imaging apparatus 100 may comprise additional components, while some components listed above may be excluded.

FIG. 2E is a block diagram illustrating possible implementation of an imaging apparatus. In this example, the imaging apparatus 100 comprises: one or more image sensors 150; one or more masks 160; and one or more color filters 180. We note that in some implementations imaging apparatus 100 may comprise additional components, while some components listed above may be excluded.

FIG. 2F is a block diagram illustrating possible implementation of an imaging apparatus. In this example, the imaging apparatus 100 comprises: one or more image sensors 150; and one or more color filters combined with masks 181. We note that in some implementations imaging apparatus 100 may comprise additional components, while some components listed above may be excluded.

In some embodiments, one or more power sources 190 may be configured to: power the imaging apparatus 100; power the computing apparatus 500; power the monitoring system 600; power a processing module 620; power an optical sensor 650; and so forth. Possible implementation examples of the one or more power sources include: one or more electric batteries; one or more capacitors; one or more connections to external power sources; any combination of the above; and so forth.

In some embodiments, the one or more processing units 120 may be configured to execute software programs, for example software programs stored on the one or more memory units 110. Possible implementation examples of the one or more processing units 120 include: one or more single core processors, one or more multicore processors; one or more controllers; one or more application processors; one or more system on a chip processors; one or more central processing units; one or more graphical processing units; one or more neural processing units; any combination of the above; and so forth.

In some embodiments, the one or more communication modules 130 may be configured to receive and transmit information. For example, control signals may be received through the one or more communication modules 130. In another example, information received though the one or more communication modules 130 may be stored in the one or more memory units 110. In an additional example, optical information captured by the one or more image sensors 150 may be transmitted using the one or more communication modules 130. In another example, optical information may be received through the one or more communication modules 130. In an additional example, information retrieved from the one or more memory units 110 may be transmitted using the one or more communication modules 130.

In some embodiments, the one or more lenses 140 may be configured to focus light on the one or more image sensors 150.

In some embodiments, the one or more image sensors 150 may be configured to capture information by converting light to: images; sequence of images; videos; optical information; and so forth. In some examples, the captured information may be stored in the one or more memory units 110. In some additional examples, the captured information may be transmitted using the one or more communication modules 130, for example to other computerized devices, such as the computing apparatus 500, the one or more processing modules 620, and so forth. In some examples, the one or more processing units 120 may control the above processes, for example: controlling the: capturing of the information; storing the captured information; transmitting of the captured information; and so forth. In some cases, the captured information may be processed by the one or more processing units 120. For example, the captured information may be compressed by the one or more processing units 120; possibly followed: by storing the compressed captured information in the one or more memory units 110; by transmitted the compressed captured information using the one or more communication modules 130; and so forth. In another example, the captured information may be processed in order to detect objects, events, people, and so forth. In another example, the captured information may be processed using: process 700, process 800, process 900, process 1000, process 1100, process 1200, process 1300, process 1400, process 1500, process 1600, process 1700, and so forth.

In some embodiments, one or more masks 160 may block at least part of the light from reaching a first group of one or more portions of the surface area of the one or more image sensors 150, and possibly allow the light to reach a second group of one or more portions of the surface area of the one or more image sensors 150. In some examples, the light may be light directed at the one or more image sensors 150. In some examples, the light may be light entering the imaging apparatus 100 through the one or more apertures 170. In some examples, the light may be light entering the imaging apparatus 100 through the one or more apertures 170 and directed at the one or more image sensors 150. In some examples, the light may be light passing through the one or more color filters 180. In some examples, the light may be light passing through the one or more color filters 180 and directed at the one or more image sensors 150. In some examples, the light may be light passing through the one or more lenses 140. In some examples, the light may be light passing through the one or more lenses 140 and directed at the one or more image sensors 150. In some examples, part of the light may be: all light; all visible light; all light that the one or more image sensors 150 are configured to capture; a specified part of the light spectrum; and so forth. In some examples, the first group of one or more portions may correspond to an amount of the surface area of the one or more image sensors 150. Examples of the amount include: ten percent, twenty percent, thirty percent, forty percent, fifty percent, sixty percent, seventy percent, eighty percent, ninety percent, ninety five percent, ninety nine percent, and so forth. In some examples, the first group of one or more portions may correspond to an amount of the pixels of the one or more image sensors 150. Examples of the amount include: ten percent, twenty percent, thirty percent, forty percent, fifty percent, sixty percent, seventy percent, eighty percent, ninety percent, ninety five percent, ninety nine percent, and so forth.

In some embodiments, one or more masks 160 may blur light reaching a first group of one or more portions of the surface area of the one or more image sensors 150, and possibly allow light to reach a second group of one or more portions of the surface area of the one or more image sensors 150 without being blurred. In some examples, the first group of one or more portions may correspond to an amount of the surface area of the one or more image sensors 150. Examples of the amount include: ten percent, twenty percent, thirty percent, forty percent, fifty percent, sixty percent, seventy percent, eighty percent, ninety percent, ninety five percent, ninety nine percent, and so forth. In some examples, the first group of one or more portions may correspond to an amount of the pixels of the one or more image sensors 150. Examples of the amount include: ten percent, twenty percent, thirty percent, forty percent, fifty percent, sixty percent, seventy percent, eighty percent, ninety percent, ninety five percent, ninety nine percent, and so forth.

In some embodiments, the one or more masks 160 may comprise at least one of: organic materials; metallic materials; aluminum; polymers; polyimide polymers; epoxy polymers; dopants that block light; photoresist; any combination of the above; and so forth.

In some embodiments, the one or more masks 160 may be configured to be positioned between the one or more lenses 140 and the one or more image sensors 150. The light focused by the one or more lenses 140 may pass through the one or more masks 160 before reaching the one or more image sensors 150. In some examples, the one or more masks 160 may block part of the light focused by the one or more lenses 140 from reaching a first group of one or more portions of the surface area of the one or more image sensors 150, and possibly allow the light focused by the one or more lenses 140 to reach a second group of one or more portions of the surface area of the one or more image sensors 150. In some examples, the one or more masks 160 may blur part of the light focused by the one or more lenses 140 on a first group of one or more portions of the surface area of the one or more image sensors 150, and possibly allow the light focused by the one or more lenses 140 to reach a second group of one or more portions of the surface area of the one or more image sensors 150 without being blurred.

In some embodiments, one or more masks may be embedded within one or more lenses, therefore creating one or more lenses with embedded masks 141. Light may be focused by the one or more lenses with embedded masks 141 on the one or more image sensors 150. In some examples, the embedded one or more masks may block part of the light focused by the one or more lenses with embedded masks 141 from reaching a first group of one or more portions of the surface area of the one or more image sensors 150, and possibly allow the light focused by the one or more lenses with embedded masks 141 to reach a second group of one or more portions of the surface area of the one or more image sensors 150. In some examples, the embedded one or more masks may blur part of the light focused by the one or more lenses with embedded masks 141 on a first group of one or more portions of the surface area of the one or more image sensors 150, and possibly allow the light focused by the one or more lenses with embedded masks 141 to reach a second group of one or more portions of the surface area of the one or more image sensors 150 without being blurred.

In some embodiments, the one or more masks 160 may be configured to be positioned between the one or more apertures 170 and the one or more image sensors 150. The light entering through the one or more apertures 170 may pass through the one or more masks 160 before reaching the one or more image sensors 150. In some examples, the one or more masks 160 may block part of the light entering through the one or more apertures 170 from reaching a first group of one or more portions of the surface area of the one or more image sensors 150, and possibly allow the light entering through the one or more apertures 170 to reach a second group of one or more portions of the surface area of the one or more image sensors 150. In some examples, the one or more masks 160 may blur part of the light entering through the one or more apertures 170 and reaching a first group of one or more portions of the surface area of the one or more image sensors 150, and possibly allow the light entering through the one or more apertures 170 to reach a second group of one or more portions of the surface area of the one or more image sensors 150 without being blurred.

In some embodiments, the one or more masks 160 may be configured to be positioned between the one or more color filters 180 and the one or more image sensors 150. The light passing through the one or more color filters 180 may pass through the one or more masks 160 before reaching the one or more image sensors 150. In some examples, the one or more masks 160 may block part of the light passing through the one or more color filters 180 from reaching a first group of one or more portions of the surface area of the one or more image sensors 150, and possibly allow the light passing through the one or more color filters 180 to reach a second group of one or more portions of the surface area of the one or more image sensors 150.

In some embodiments, one or more masks may be combined with one or more color filters, therefore creating one or more color filters combined with masks 181. The one or more color filters combined with masks 181 may be positioned before the one or more image sensors 150, such that at least part of the light reaching the one or more image sensors 150 may pass through the one or more color filters combined with masks 181. In such cases, the one or more masks may block part of the light reaching the one or more color filters combined with masks 181 from reaching a first group of one or more portions of the surface area of the one or more image sensors 150, and possibly allow the light passing through the one or more color filters combined with masks 181 to reach a second group of one or more portions of the surface area of the one or more image sensors 150. The light that does pass through the one or more color filters combined with masks 181 may be filtered in order to enable the one or more image sensors 150 to capture color pixels.

In some embodiments, one or more masks may be combined with one or more micro lens arrays, therefore creating a micro lens array combined with a mask such as the micro lens array combined with a mask 420. One or more micro lens arrays combined with masks may be positioned before the one or more image sensors 150, such that at least part of the light reaching the one or more image sensors 150 may pass through the one or more micro lens arrays combined with masks. In such cases, the one or more masks may block part of the light reaching the one or more micro lens arrays combined with a masks 420 from reaching a first group of one or more portions of the surface area of the one or more image sensors 150, and possibly allow the light passing through the one or more micro lens arrays combined with a masks 420 to reach a second group of one or more portions of the surface area of the one or more image sensors 150. The light that does pass through the one or more micro lens arrays combined with masks may be concentrated into active capturing regions of the one or more image sensors 150.

In some embodiments, one or more masks may be directly formed on an image sensor, therefore creating a mask directly formed on an image sensor, such as a mask directly formed on an image sensor 430. In some embodiments, one or more color filters combined with masks may be directly formed on an image sensor. In some embodiments, one or more micro lens arrays combined with masks may be directly formed on an image sensor. In some embodiments, one or more masks, such as one or more masks 160, may be glued to the one or more image sensors 150. In some embodiments, one or more color filters combined with masks, such as one or more color filters combined with masks 181, may be glued to the one or more image sensors 150. In some embodiments, one or more micro lens arrays combined with masks, such as micro lens array combined with a mask 420, may be glued to the one or more image sensors 150.

In some embodiments, at least one mask comprises of regions, the type of each region is one of a plurality of types of regions. Example of such masks may include: the one or more masks 160; masks of the one or more regions 410; and so forth. Each type of region may include different opacity characteristics. Some examples of the opacity characteristics may include: blocking all light; blocking all visible light; blocking all light that the one or more image sensors 150 are configured to capture; blocking a specified part of the light spectrum while allowing other part of the light spectrum to pass through; allowing all light to pass through; allowing all visible light to pass through; allowing all light that the one or more image sensors 150 are configured to capture to pass through; and so forth. Some additional examples of the opacity characteristics may include blocking a specified amount of: all light; all visible light; the light that the one or more image sensors 150 are configured to capture; the light of a given spectrum; and so forth. Examples of the specified amount may include: ten percent, twenty percent, thirty percent, forty percent, fifty percent, sixty percent, seventy percent, eighty percent, ninety percent, ninety five percent, ninety nine percent, and so forth. Examples of the number of types in the plurality of types of regions include: two types; three types; four types; at least five types; at least ten types; at least fifty types; at least one hundred types; at least one thousand types; at least one million types; and so forth.

In some examples, regions of a first type may block part of the light from reaching one or more portions of the one or more image sensors 150. In some examples, the one or more portions may correspond to a percent of the surface area of the one or more image sensors 150. Examples of the percent of the surface area may include: ten percent, twenty percent, thirty percent, forty percent, fifty percent, sixty percent, seventy percent, eighty percent, ninety percent, ninety five percent, ninety nine percent, and so forth. In some examples, the one or more portions may correspond to a percent of the pixels of the one or more image sensors 150. Examples of the percent of the pixels may include: ten percent, twenty percent, thirty percent, forty percent, fifty percent, sixty percent, seventy percent, eighty percent, ninety percent, ninety five percent, ninety nine percent, and so forth. In some examples, regions of at least one type other than the first type may be configured to allow light to reach a second set of one or more portions of the one or more image sensors 150.

In some examples, regions of one type may allow light to pass through, while regions of another type may block light from passing through. In another example, regions of one type may allow all light to pass through, while regions of another type may block part of the light from passing through. In an additional example, regions of one type may allow part of the light to pass through, while regions of another type may block all light from passing through. In another example, regions of one type may allow a first part of the light to pass through while blocking other part of the light; and regions of a second type may allow a second part of the light to pass through while blocking other part of the light; where the characteristics of the first part of the light differ from the characteristics of the second part of the light, for example in the percentage of light passing, in the spectrum of the passing light, and so forth.

In some embodiments, at least one mask comprises regions, the type of each region is one of a plurality of types of regions. Example of such masks may include: the one or more masks 160; masks of the one or more regions 410; and so forth. Each type of regions may be characterized by different blurring characteristics. Some examples of the blurring characteristics may include: blurring the input to become visually unrecognizable; blurring the input to be partly visually recognizable; blurring the input while keeping it visually recognizable; not blurring the input; and so forth. Examples of the number of types in the plurality of types of regions include: two types; three types; four types; at least five types; at least ten types; at least fifty types; at least one hundred types; at least one thousand types; at least one million types; and so forth.

In some embodiments, the one or more additional sensors 155 may be configured to capture information from an environment. For example, at least one of the one or more additional sensors 155 may be an audio sensor configured to capture audio data from the environment. In another example, at least one of the one or more additional sensors 155 may be an ultrasound sensor configured to capture ultrasound images, ultrasound videos, range images, range videos, and so forth. In an additional example, at least one of the one or more additional sensors 155 may be a 3D sensor, configured to capture: 3D images; 3D videos; range images; range videos; stereo pair images; 3D models; and so forth. Examples of such 3D models may include: points cloud; group of polygons; hypergraph; skeleton model; and so forth. Examples of such 3D sensors may include: stereoscopic camera; time-of-flight camera; obstructed light sensor; structured light sensor; LIDAR; and so forth. In an additional example, at least one of the one or more additional sensors 155 may be a positioning sensor configured to obtain positioning information of the imaging apparatus 100. In an additional example, at least one of the one or more additional sensors 155 may be an accelerometer configured to obtain motion information of the imaging apparatus 100.

In some embodiments, information captured from the environment using the one or more additional sensors 155 may be used in conjunction with information captured from the environment using the one or more image sensors 150. Throughout this specification, unless specifically stated otherwise, calculations, determinations, identifications, steps, decision rules, processes, methods, apparatuses, systems, algorithms, and so forth, based on information captured from the environment using the one or more image sensors 150, may also be based on information captured from the environment using the one or more additional sensors 155. For example, the following steps may also be based on information captured from the environment using the one or more additional sensors 155: determining if an item is present (Step 720); determining if an event occurred (Step 820); obtaining an estimation of the number of people present (Step 920); determining if the number of people equals or exceeds a maximum threshold (Step 1020); determining if no person is present (Step 1120); determining if the object is not present and no person is present (Step 1220); determining if the object is present and no person is present (Step 1240); determining if a lavatory requires maintenance (Step 1420); detecting smoke and/or fire (Step 1520); detecting one or more persons (Step 1620); detecting a distress condition (Step 1630); detecting a sexual harassment and/or a sexual assault (Step 1730); and so forth.

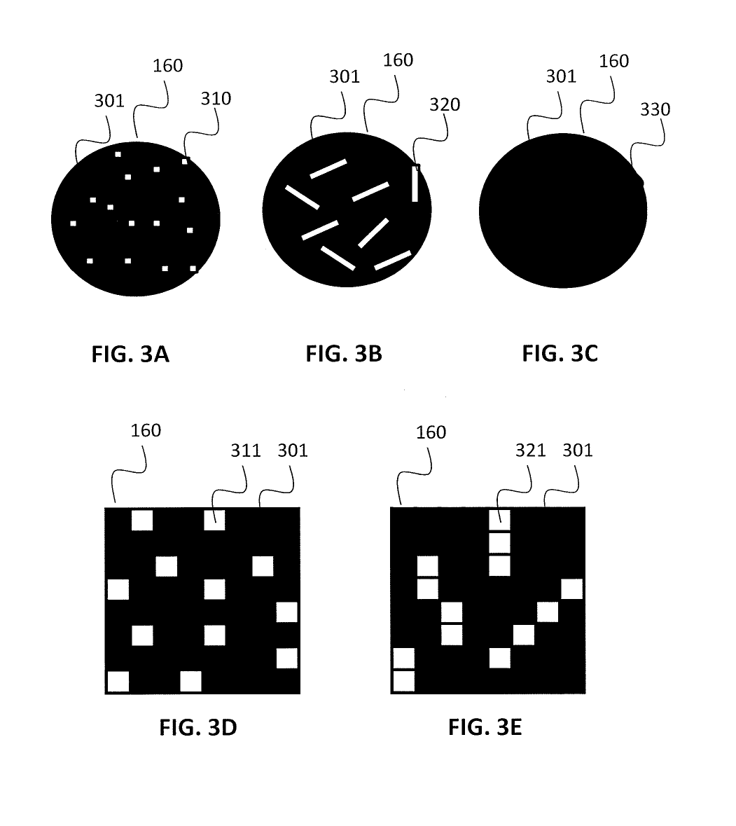

FIG. 3A is a schematic illustration of an example of a mask. In this example, the mask 160 comprises: a plurality of regions of a first type, shown in white, such as region 310; and one or more regions 301 of a second type, shown in black. In this example, the regions of the first type are square in shape. Some examples of such square shapes may include regions corresponding in the one or more image sensors 150 to: a single pixel; two by two pixels; three by three pixels; four by four pixels; a square of at least five by five pixels; a square of at least ten by ten pixels; a square of at least twenty by twenty pixels; and so forth. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light. In some examples, the regions of the first type may be arranged in a repeated pattern, while in other examples the regions of the first type may be arranged in an irregular pattern.

FIG. 3B is a schematic illustration of an example of a mask. In this example, the mask 160 comprises: a plurality of regions of a first type, shown in white, such as region 320; and one or more regions 301 of a second type, shown in black. In this example, the regions of the first type are rectangular in shape. Some examples of such rectangular shapes may include regions corresponding to rectangular regions in the one or more image sensors, including rectangular regions corresponding to n by m pixels in the one or more image sensors 150. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light. In some examples, the regions of the first type may be arranged in a repeated pattern, while in other examples the regions of the first type may be arranged in an irregular pattern.

FIG. 3C is a schematic illustration of an example of a mask. In this example, the mask 160 comprises: a plurality of regions of a first type, shown in white, such as region 330; and one or more regions 301 of a second type, shown in black. In this example, the regions of the first type are of a curved shape. In some examples, the same curved shape may repeat again and again in the mask, while in other examples multiple different curved shapes may be used. In some cases, the curved shapes may correspond to curved shapes in the one or more image sensors 150. In such cases, the corresponding curved shapes in the one or more image sensors may be of: a single pixel thickness; two pixels thickness; three pixels thickness; four pixels thickness; at least five pixels thickness; varying thickness; and so forth. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light. In some examples, the regions of the first type may be arranged in a repeated pattern, while in other examples the regions of the first type may be arranged in an irregular pattern.

FIG. 3D is a schematic illustration of an example of a portion of a mask. In this example, the mask 160 comprises: a plurality of regions of a first type, shown in white, such as region 311; and one or more regions 301 of a second type, shown in black. In this example, each region of the first type corresponds to a single pixel in the one or more image sensors 150. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light.

FIG. 3E is a schematic illustration of an example of a portion of a mask. In this example, the mask 160 comprises: a plurality of regions of a first type, shown in white, such as region 321; and one or more regions 301 of a second type, shown in black. In this example, each region of the first type corresponds to a line of pixels in the one or more image sensors 150. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light.

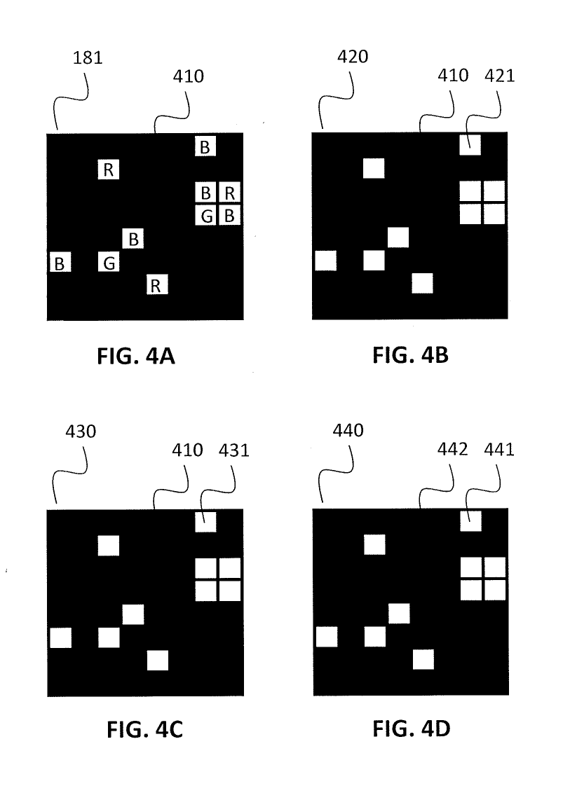

FIG. 4A is a schematic illustration of an example of a portion of a color filter combined with a mask. In this example, the color filter combined with a mask 181 comprises: one or more regions 410 of a mask, shown in black; one or more regions of color filters, shown in white. In general, each region of the color filters may filter part of the light spectrum in order to enable the one or more image sensors 150 to capture color pixels. In this example: regions corresponding to green input to the one or more image sensors 150 are denoted with ‘G’; regions corresponding to red input to the one or more image sensors 150 are denoted with ‘R’; regions corresponding to blue input to the one or more image sensors 150 are denoted with ‘B’. Other examples may include other filters, corresponding to other color input to the one or more image sensors 150. Other examples may include different patterns of regions, masks, colors, and so forth, including: repeated patterns, irregular patterns, and so forth. In some examples, the captured pixels may comprise: one color component; two color components; three color components; at least four color components; any combination of the above; and so forth.

FIG. 4B is a schematic illustration of an example of a portion of a micro lens array combined with a mask 420. In this example, the micro lens array combined with a mask 420 comprises: one or more regions 410 of a mask, shown in black; one or more regions of micro lenses, such as region 421, shown in white. In some examples, the micro lenses are configured to concentrate light into active capturing regions of the one or more image sensors 150. Other examples may include different patterns of regions, masks, and so forth, including: repeated patterns, irregular patterns, and so on.

FIG. 4C is a schematic illustration of an example of a portion of a mask directly formed on an image sensor. In this example, the mask directly formed on an image sensor 430 comprises: a plurality of regions of a first type, shown in white, such as region 431; and one or more regions 410 of a second type, shown in black. In some cases, the one or more regions of the second type may correspond to regions with a mask, while the plurality of regions of the first type may correspond to regions without a mask. In some cases, the regions of the first type may allow light to pass through, while regions of the second type may block at least part of the light. In some cases, the regions of the first type may allow at least part of the light to pass through, while regions of the second type may block all light. In some cases, the regions of the first type may block a first part of the light, while regions of the second type may block a second part of the light. In some examples, the regions of the first type may be arranged in a repeated pattern, while in other examples the regions of the first type may be arranged in an irregular pattern.

In some embodiments, manufacturing the mask directly formed on an image sensor 430 may comprise post processing integrated circuit dies. In some examples, the post processing of the integrated circuit dies may comprise at least some of: spin coating a layer of photoresist; exposing the photoresist to a pattern of light; developing using a chemical developer; etching; photoresist removal; and so forth. In some examples, the mask directly formed on an image sensor 430 may comprise at least one of: organic materials; metallic materials; aluminum; polymers; polyimide polymers; epoxy polymers; dopants that block light; photoresist; any combination of the above; and so forth.

FIG. 4D is a schematic illustration of an example of a portion of an image sensor with sparse pixels. In this example, the image sensor with sparse pixels 440 comprises: plurality of regions configured to convert light to pixels, shown in white, such as region 441; and one or more regions that are not configured to convert light to pixels, shown in black, such as region 442. The image sensor with sparse pixels 440 may be configured to generate output with sparse pixels. In some examples, the one or more regions that are not configured to convert light to pixels may comprise one or more logic circuits, and in some cases at least one of the one or more processing units 120 may be implemented using these one or more logic circuits. In some examples, the one or more regions that are not configured to convert light to pixels may comprise memory circuits, and in some cases at least one of the one or more memory units 110 may be implemented using these memory circuits.

In some embodiments, a privacy preserving optical sensor may be implemented as imaging apparatus 100. In some examples, the one or more processing units 120 may modify information captured by the one or more image sensors 150 to be visually unrecognizable before any output is made. For example, some of the pixels of the captured images and videos may be modified in order to make the images and videos visually unrecognizable. In some examples, the one or more processing units 120 may sample a fraction of the pixels captured by the one or more image sensors 150, for example in a way which ensures that the sampled pixels form visually unrecognizable information. For example, the fraction of the pixels sampled may be less than: one percent of the pixels; two percent of the pixels; ten percent of the pixels; and so forth. In some cases, the sampled pixels may be scattered over the input pixels. For example, the sampled pixels may be scattered so that the maximal width of a continuous region of sampled pixels is at most: one pixel; two pixels; three pixels; four pixels; five pixels; at most ten pixels; at most twenty pixels; and so forth. For example, the sampled pixels may be scattered into non continuous fractions so that the number of fractions is: at least ten; at least fifty; at least one hundred; at least one thousand; at least one million; and so forth.

In some embodiments, a privacy preserving optical sensor may be implemented as imaging apparatus 100. In some examples, the one or more processing units 120 may process the information captured by the one or more image sensors 150, outputting the result of the processing while discarding the captured information. For example, such processing may include at least one of: machine learning algorithms; deep learning algorithms; artificial intelligent algorithms; computer vision algorithms; algorithms based on neural networks; process 700; process 800; process 900; process 1000; process 1100; process 1200; process 1300; process 1400; and so forth. In another example, such processing may include feature extraction algorithms, outputting the detected features. In an additional example, such processing may include applying one or more layers of a neural network on the captured information, outputting the output of the one or more layers, which in turn may be used by an external device as the input to further layers of a neural network.

In some embodiments, a permanent privacy preserving optical sensor may be implemented as imaging apparatus 100. For example, one or more masks may render the optical input to the one or more image sensors 150 visually unrecognizable. Example of such masks may include: the one or more masks 160; masks of the one or more regions 410; and so forth. In another example, one or more lenses with embedded masks 141 may render the optical input to the one or more image sensors 150 visually unrecognizable. In an additional example, one or more color filters combined with masks 181 may render the optical input to the one or more image sensors 150 visually unrecognizable. In another example, the one or more image sensors 150 may be implemented as one or more image sensors with sparse pixels 440, and the output of the one or more image sensors with sparse pixels 440 may be sparse enough to be visually unrecognizable.

In some embodiments, a privacy preserving optical sensor may be implemented as imaging apparatus 100. In some cases, the one or more processing units 120 may be configured to execute privacy preserving software. The privacy preserving software may modify information captured by the one or more image sensors 150 into information that is visually unrecognizable. For example, the privacy preserving software may modify some of the pixels of the captured images and videos in order to make the images and videos visually unrecognizable. In some examples, the privacy preserving software may sample a fraction of the pixels captured by the one or more image sensors 150, for example in a way which ensures that the sampled pixels form visually unrecognizable information. For example, the fraction of the pixels sampled may be less than: one percent of the pixels; two percent of the pixels; ten percent of the pixels; and so forth. In some cases, the sampled pixels may be scattered over the input pixels. For example, the sampled pixels may be scattered so that the maximal width of a continuous region of sampled pixels is at most: one pixel; two pixels; three pixels; four pixels; five pixels; at most ten pixels; at most twenty pixels; and so forth. For example, the sampled pixels may be scattered into non continuous fractions so that the number of fractions is: at least ten; at least fifty; at least one hundred; at least one thousand; at least one million; and so forth. In case where the privacy preserving software cannot be modified without physically modifying the imaging apparatus 100, this implementation is a permanent privacy preserving optical sensor.

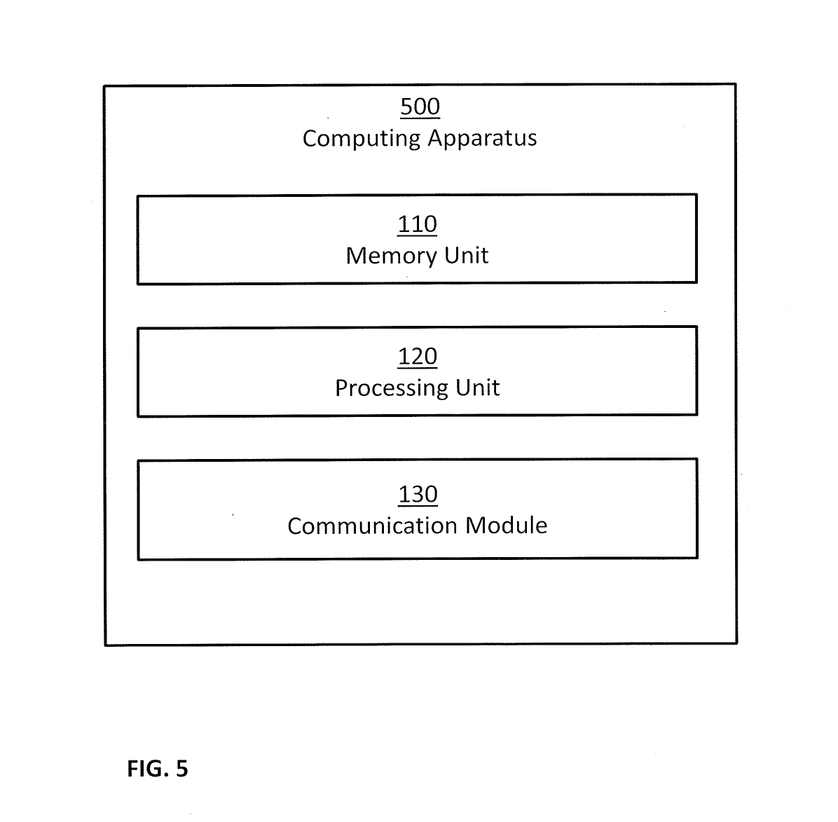

FIG. 5 is a block diagram illustration of an example of a possible implementation of a computing apparatus 500. In this example, the computing apparatus 500 comprises: one or more memory units 110; one or more processing units 120; one or more communication modules 130. In some implementations computing apparatus 500 may comprise additional components, while some components listed above may be excluded. For example, one possible implementation of computing apparatus 500 is imaging apparatus 100.

In some embodiments, indications, information, and feedbacks may be provided as output. The output may be provided: in real time; offline; automatically; upon detection of a trigger; upon request; and so forth. In some embodiments, the output may comprise audio output. The audio output may be provided to a user, for example using one or more audio outputting units, such as headsets, audio speakers, and so forth. In some embodiments, the output may comprise visual output. The visual output may be provided to a user, for example using one or more visual outputting units such as display screens, augmented reality display systems, printers, LED indicators, and so forth. In some embodiments, the output may comprise tactile output. The tactile output may be provided to a user using one or more tactile outputting units, for example through vibrations, motions, by applying forces, and so forth. In some embodiments, the output information may be transmitted to another computerized device, for example using the one or more communication modules 130. In some cases, indications, information, and feedbacks may be provided to a user by the other computerized device.

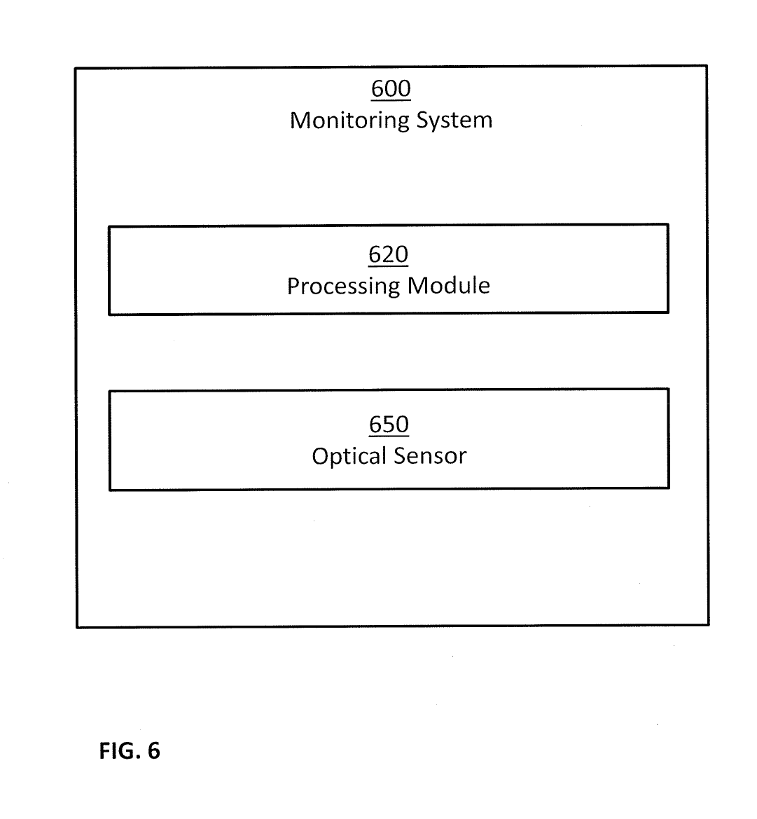

FIG. 6 is a block diagram illustration of an example of a possible implementation of a monitoring system 600. In this example, the monitoring system 600 comprises: one or more processing modules 620; and one or more optical sensors 650. In some implementations monitoring system 600 may comprise additional components, while some components listed above may be excluded. For example, in some cases monitoring system 600 may also comprise one or more of the followings: one or more memory units; one or more communication modules; one or more lenses; one or more power sources; and so forth. In some examples, the monitoring system 600 may comprise: one optical sensor; two optical sensors; three optical sensors; four optical sensors; at least five optical sensors; at least ten optical sensors; at least one hundred optical sensors; and so forth.

In some embodiments, the monitoring system 600 may be implemented as imaging apparatus 100. In such case, the one or more processing modules 620 are the one or more processing units 120; and the one or more optical sensors 650 are the one or more image sensors 150.

In some embodiments, the monitoring system 600 may be implemented as a distributed system, implementing the one or more optical sensors 650 as one or more imaging apparatuses, and implementing the one or more processing modules 620 as one or more computing apparatuses. In some examples, each one of the one or more processing modules 620 may be implemented as computing apparatus 500. In some examples, each one of the one or more optical sensors 650 may be implemented as imaging apparatus 100.

In some embodiments, the one or more optical sensors 650 may be configured to capture information by converting light to: images; sequence of images; videos; optical information; and so forth. In some examples, the captured information may be delivered to the one or more processing modules 620. In some embodiments, the captured information may be processed by the one or more processing modules 620. For example, the captured information may be compressed by the one or more processing modules 620. In another example, the captured information may be processed by the one or more processing modules 620 in order to detect objects, events, people, and so forth.

In some embodiments, at least one of the one or more optical sensors 650 is a privacy preserving optical sensor. In some embodiments, at least one of the one or more optical sensors 650 is a permanent privacy preserving optical sensor. In some embodiments, at least one of the one or more optical sensors 650 is a permanent privacy preserving optical sensor that cannot be turned into an optical sensor that is not a privacy preserving optical sensor without being physically damaged. In some embodiments, all of the one or more optical sensors 650 are privacy preserving optical sensors. In some embodiments, all of the one or more optical sensors 650 are permanent privacy preserving optical sensors. In some embodiments, all of the one or more optical sensors 650 are permanent privacy preserving optical sensors that cannot be turned into an optical sensor that is not a privacy preserving optical sensor without being physically damaged.

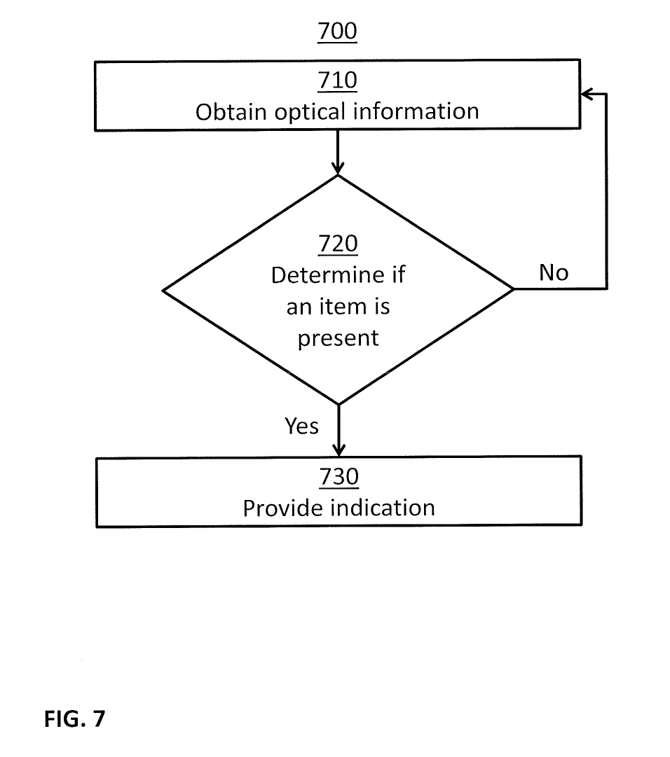

FIG. 7 illustrates an example of a process 700 for providing indications. In some examples, process 700, as well as all individual steps therein, may be performed by various aspects of: imaging apparatus 100; computing apparatus 500; and so forth. For example, process 700 may be performed by the one or more processing units 120, executing software instructions stored within the one or more memory units 110. In another example, process 700 may be performed by the one or more processing modules 620. Process 700 comprises: obtaining optical information (Step 710); determining if an item is present (Step 720); providing indications (Step 730). In some implementations, process 700 may comprise one or more additional steps, while some of the steps listed above may be modified or excluded. Examples of possible execution manners of process 700 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, obtaining optical information (Step 710) may comprise capturing the optical information, for example: using the one or more image sensors 150; using imaging apparatus 100; using the one or more optical sensors 650; and so forth. In some embodiments, obtaining optical information (Step 710) may comprise receiving the optical information through a communication module, such as the one or more communication modules 130. In some embodiments, obtaining optical information (Step 710) may comprise reading the optical information from a memory unit, such as the one or more memory units 110.

In some embodiments, optical information may comprise at least one of: images; sequence of images; videos; and so forth. In some embodiments, optical information may comprise information captured using one or more optical sensors. Some possible examples of such optical sensors may include: one or more image sensors 150; one or more imaging apparatuses 100; one or more optical sensors 650; and so forth. In some embodiments, optical information may comprise information captured using one or more privacy preserving optical sensors. In some embodiments, optical information may comprise information captured using one or more permanent privacy preserving optical sensors. In some embodiments, optical information does not include any visually recognizable images, visually recognizable sequence of images, and/or visually recognizable videos of the environment.

In some embodiments, determining if an item is present (Step 720) may comprise determining a presence of one or more items in an environment based on the optical information. In some cases, detection algorithms may be applied in order to determine the presence of the one or more items. In other cases, determining if an item is present (Step 720) may also be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; some optical information instances captured when an item is present and labeled accordingly; while other optical information instances captured when an item is not present and labeled accordingly. In an additional example, at least one of the one or more decision rules may be the result of deep learning algorithms. In another example, at least one of the one or more decision rules may be based, at least in part, on the output of one or more neural networks, such as the output obtained by applying the one or more neural networks on the optical information.

In some embodiments, the one or more items may comprise one or more objects. Determining if an item is present (Step 720) may comprise determining a presence of one or more objects in an environment based on the optical information. In some embodiments, a list of one or more specified object categories may be obtained. Examples of such object categories may include: a category of weapon objects; a category of cutting objects; a category of flammable objects; a category of pressure container objects; a category of strong magnets; and so forth. Examples of weapon objects may include: explosives; gunpowder; black powder; dynamite; blasting caps; fireworks; flares; plastic explosives; grenades; tear gas; pepper spray; pistols; guns; rifles; firearms; firearm parts; ammunition; knives; swords; replicas of any of the above; and so forth. Examples of cutting objects may include: knives; swords; box cutters; blades; any device including blades; scissors; replicas of any of the above; and so forth. Examples of flammable objects may include: gasoline; gas torches; lighter fluids; cooking fuel; liquid fuel; flammable paints; paint thinner; turpentine; aerosols; replicas of any of the above; and so forth. Examples of pressure container objects may include: aerosols; carbon dioxide cartridges; oxygen tanks; tear gas; pepper spray; self-inflating rafts; containers of deeply refrigerated gases; spray paints; replicas of any of the above; and so forth. Determining if an item is present (Step 720) may comprise determining, based on the optical information, a presence of one or more objects of the one or more specified object categories in an environment.

In some embodiments, the one or more items may comprise one or more animals. Determining if an item is present (Step 720) may comprise determining a presence of one or more animals in an environment based on the optical information. In some embodiments, a list of one or more specified animal types may be obtained. Examples of such animal types may include: dogs; cats; snakes; rabbits; ferrets; rodents; canaries; parakeets; parrots; turtles; lizards; fishes; avian animals; reptiles; aquatic animals; wild animals; pets; farm animals; predators; and so forth. Determining if an item is present (Step 720) may comprise determining, based on the optical information, a presence of one or more animals of the one or more specified animal types in an environment.

In some embodiments, the one or more items may comprise one or more persons. Determining if an item is present (Step 720) may comprise determining a presence of one or more persons in an environment based on the optical information. In some embodiments, a list of one or more specified persons may be obtained. For example, such list may include: allowed personnel; banned persons; and so forth. In some embodiments, determining if an item is present (Step 720) may comprise determining, based on the optical information, a presence of one or more persons of the list of one or more specified persons in an environment. For example, face recognition algorithms may be used in order to identify if a detected person is in the list of one or more specified persons, and it is determined that a person is present if it was identified that at least one detected person is in the list of one or more specified persons from the list is recognized in the environment. In some embodiments, determining if an item is present (Step 720) may comprise determining, based on the optical information, a presence of one or more persons that are not in the list of one or more specified persons is in an environment. For example, face recognition algorithms may be used in order to identify if a detected person is in the list of one or more specified persons.

In some embodiments, if it is determined that the one or more items are not present in the environment (Step 720: No), process 700 may end. In other embodiments, if it is determined that the one or more items are not present in the environment (Step 720: No), process 700 may return to Step 710. In some embodiments, if it is determined that the one or more items are not present in the environment (Step 720: No), other processes may be executed, such as process 800, process 900, process 1000, process 1100, process 1200, process 1300, process 1400, process 1500, process 1600, process 1700, and so forth. In some embodiments, if it is determined that the one or more items are present in the environment (Step 720: Yes), process 700 may provide indication (Step 730).

In some embodiments, the indication that process 700 provides in Step 730 may be provided in the fashion described above. In some examples, an indication regarding the presence of a person in an environment may be provided. In some cases, the indication may also include information associated with: the location of the person; the identity of the person; the number of people present; the time the person first appeared; the times at which the person was present; actions performed by the person; and so forth. In some cases, the indication may be provided when properties associated with the person and/or with the presence of the person in the environment meet certain conditions. For instance, an indication may be provided: when the duration of the presence exceeds a specified threshold; when the identity of the person is not in an exception list; and so forth. In another example, an indication regarding the presence of an object in an environment may be provided. In some cases, the indication may also include information associated with: the location of the object; the type of the object; the number of objects present; the time the object first appeared; the times at which the object was present; events associated with the object; and so forth. In some cases, the indication may be provided when properties associated with the object and/or with the presence of the object in the environment meet certain conditions. For instance, an indication may be provided: when the duration of the presence exceeds a specified threshold; when the type of the object is of a list of specified types; when the size of the object is at least a minimal size; and so forth.

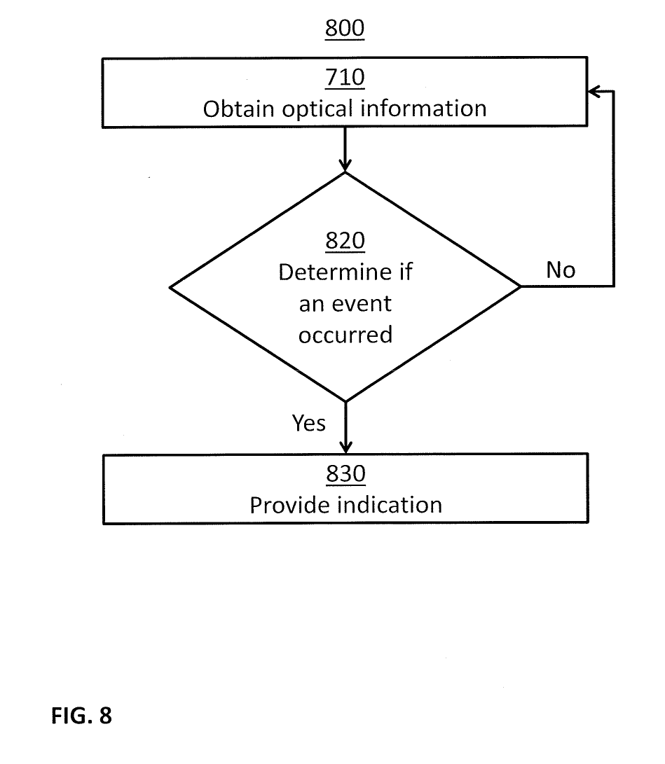

FIG. 8 illustrates an example of a process 800 for providing indications. In some examples, process 800, as well as all individual steps therein, may be performed by various aspects of: imaging apparatus 100; computing apparatus 500; and so forth. For example, process 800 may be performed by the one or more processing units 120, executing software instructions stored within the one or more memory units 110. In another example, process 800 may be performed by the one or more processing modules 620. Process 800 comprises: obtaining optical information (Step 710); determining if an event occurred (Step 820); providing indications (Step 830). In some implementations, process 800 may comprise one or more additional steps, while some of the steps listed above may be modified or excluded. Examples of possible execution manners of process 800 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, determining if an event occurred (Step 820) may comprise determining an occurrence of one or more events based on the optical information. In some cases, event detection algorithms may be applied in order to determine the occurrence of the one or more events. In other cases, determining if an event occurred (Step 820) may also be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; some optical information instances captured when an event occurs and labeled accordingly; while other optical information instances captured when an event does not occur and labeled accordingly. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, the one or more events may comprise one or more actions performed by at least one person. Determining if an event occurred (Step 820) may comprise determining if at least one person in the environment performed one or more actions based on the optical information. In some embodiments, a list of one or more specified actions may be obtained. Examples of such actions may include one or more of: painting; smoking; igniting fire; breaking an object; and so forth. Determining if an event occurred (Step 820) may comprise determining, based on the optical information, if at least one person in the environment performed one or more actions of the list of one or more specified actions. For example, action recognition algorithms may be used in order to identify if a detected action is in the list of one or more specified actions, and it is determined that an event occurred if it was identified that at least one detected action is in the list of one or more specified actions. In some embodiments, determining if an event occurred (Step 820) may comprise determining, based on the optical information, if at least one person of a list of one or more specified persons is present in the environment, and if that person performed one or more actions of a list of one or more specified actions. In some embodiments, determining if an event occurred (Step 820) may comprise determining, based on the optical information, if at least one person present in the environment is not in a list of one or more specified persons, and if that person performed one or more actions of a list of one or more specified actions.

In some embodiments, at least one of the one or more events may comprise one or more changes in the state of at least one object. Determining if an event occurred (Step 820) may comprise determining, based on the optical information, if the state of at least one object in the environment changed. In some embodiments, a list of one or more specified changes in states may be obtained. Examples of such changes in states may include one or more of: a dispenser becomes empty; a dispenser becomes nearly empty; a lavatory becomes flooded; garbage can becomes full; garbage can becomes nearly full; floor becomes unclean; equipment become broken; equipment become malfunctioning; wall becomes painted; light bulb turned off; and so forth. Determining if an event occurred (Step 820) may comprise determining, based on the optical information, if the state of at least one object in the environment changed, and if the change in the state is of the list of one or more specified changes in states. In some embodiments, determining if an event occurred (Step 820) may comprise determining, based on the optical information, if at least one object of a list of one or more specified object categories is present in the environment, if the state of that object changed, and if the change in state is of the list of one or more specified changes in states.

In some embodiments, if it is determined that the one or more events did not occur (Step 820: No), process 800 may end. In other embodiments, if it is determined that the one or more events did not occur (Step 820: No), process 800 may return to Step 710. In some embodiments, if it is determined that the one or more events did not occur (Step 820: No), other processes may be executed, such as process 700, process 900, process 1000, process 1100, process 1200, process 1300, process 1400, process 1500, process 1600, process 1700, and so forth. In some embodiments, if it is determined that the one or more events occurred (Step 820: Yes), process 800 may provide indication (Step 830).

In some embodiments, the indication that process 800 provides in Step 830 may be provided in the fashion described above. In some examples, an indication regarding the occurrence of an event may be provided. In some cases, the indication may also include information associated with: one or more locations associated with the event; the type of the event; the time the event occurred; properties associated with the event; and so forth. In some cases, the indication may be provided when properties associated with the event meet certain conditions. For instance, an indication may be provided: when the duration of the event exceeds a specified threshold; when the type of the event is of a list of specified types; and so forth.

In some embodiments, a process for providing indications may comprise: obtaining optical information (Step 710); determining if an item is present (Step 720); providing indications (Step 730); determining if an event occurred (Step 820); providing indications (Step 830). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

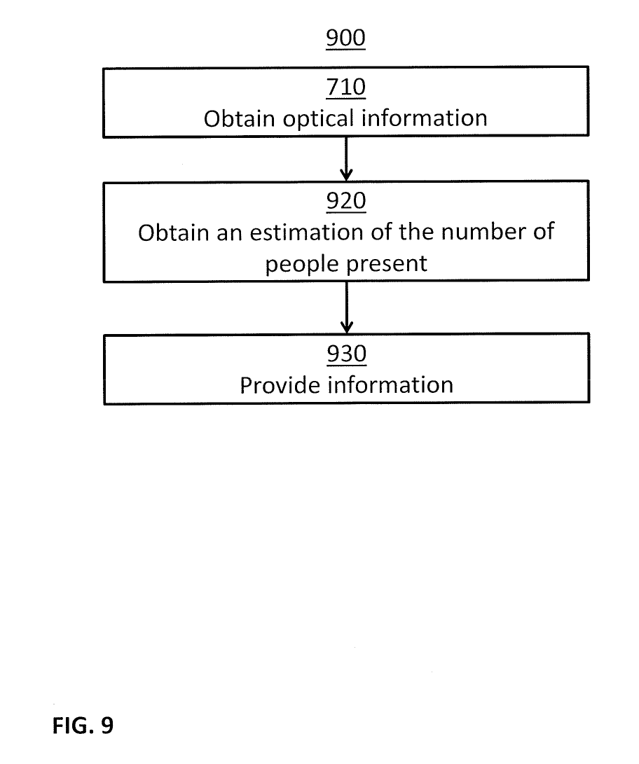

FIG. 9 illustrates an example of a process 900 for providing information. In some examples, process 900, as well as all individual steps therein, may be performed by various aspects of: imaging apparatus 100; computing apparatus 500; and so forth. For example, process 900 may be performed by the one or more processing units 120, executing software instructions stored within the one or more memory units 110. In another example, process 900 may be performed by the one or more processing modules 620. Process 900 comprises: obtaining optical information (Step 710); obtaining an estimation of the number of people present (Step 920); providing information (Step 930). In some implementations, process 900 may comprise one or more additional steps, while some of the steps listed above may be modified or excluded. Examples of possible execution manners of process 900 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, obtaining an estimation of the number of people present (Step 920) may comprise estimating the number of people present in an environment, for example based on the optical information. In some cases, detection algorithms may be applied on the optical information in order to detect people in the environment, and the number of detected people may be counted in order to obtain an estimation of the number of people present in the environment. In other cases, obtaining an estimation of the number of people present (Step 920) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled with the number of people present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information. In some cases, obtaining an estimation of the number of people present (Step 920) may be based on one or more regression models. For example, the one or more regression models may be stored in a memory unit, such as the one or more memory units 110, and the regression models may be obtained by accessing the memory unit and reading the rules. For example, at least one of the one or more regression models may be preprogrammed manually. In another example, at least one of the one or more regression models may be the result of training machine learning algorithms on training examples, such as the training examples described above. In an additional example, at least one of the one or more regression models may be the result of deep learning algorithms. In another example, at least one of the one or more regression models may be based, at least in part, on the output of one or more neural networks, such as the output obtained by applying one or more neural networks on the optical information.

In some embodiments, obtaining an estimation of the number of people present (Step 920) may consider people that meet specified criterions while ignoring all other people in the estimation. For example: only people older than a certain age may be considered; only people younger than a certain age may be considered; only people of a certain gender may be considered; only people present in the environment for a period of time longer than a specified duration may be considered; only people from a list of specified persons may be considered; any combination of the above; and so forth.

In some embodiments, obtaining an estimation of the number of people present (Step 920) may ignore people that meet specified criterions. For example: people older than a certain age may be ignored; people younger than a certain age may be ignored; people of a certain gender may be ignored; people present in the environment for a period of time shorter than a specified duration may be ignored; people from a list of specified persons may be ignored; any combination of the above; and so forth.

In some embodiments, process 900 may provide information (Step 930). In some examples, the information that process 900 provides in Step 930 may be provided in the fashion described above. In some examples, information associated with the estimated number of people may be provided. In some cases, information associated with the estimated number of people may include information associated with: the estimated number of people; one or more locations associated with the detected people; the estimated ages of the detected people; the estimated heights of the detected people; the estimated genders of the detected people; the times at which the people were detected; properties associated with the detected people; and so forth. In some cases, the information may be provided when properties associated with the detected people meet certain conditions. For instance, the information may be provided: when the estimated number of people exceeds a specified threshold; when the estimated number of people is lower than a specified threshold; when the estimated number of people older than a certain age exceeds a specified threshold; when the estimated number of people older than a certain age is lower than a specified threshold; when the estimated number of people younger than a certain age exceeds a specified threshold; when the estimated number of people younger than a certain age is lower than a specified threshold; when the estimated number of people of a certain gender exceeds a specified threshold; when the estimated number of people of a certain gender is lower than a specified threshold; when the estimated number of people exceeds a specified threshold for a time period longer than a specified duration; when the estimated number of people is lower than a specified threshold for a time period longer than a specified duration; any combination of the above; and so forth.

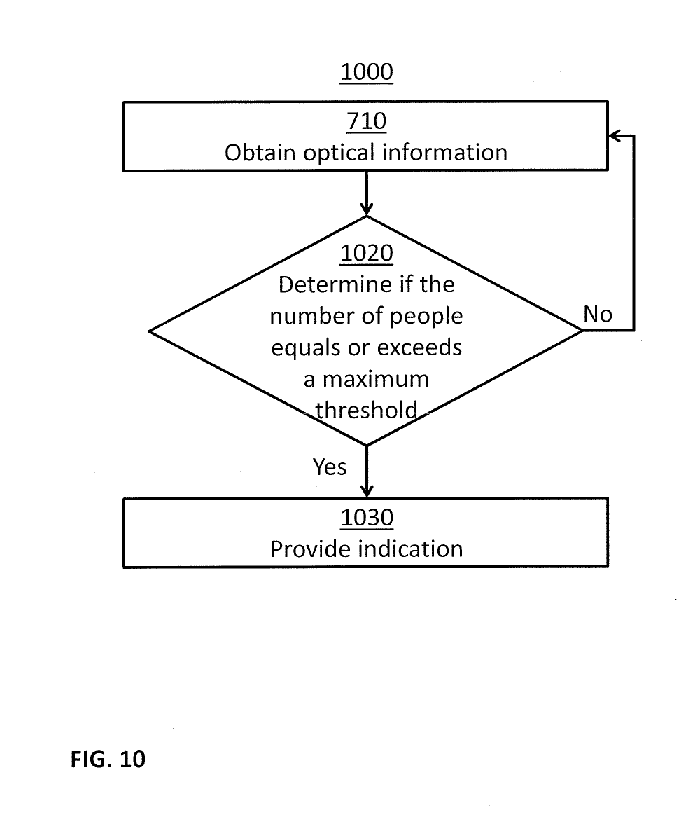

FIG. 10 illustrates an example of a process 1000 for providing indications. In some examples, process 1000, as well as all individual steps therein, may be performed by various aspects of: imaging apparatus 100; computing apparatus 500; and so forth. For example, process 1000 may be performed by the one or more processing units 120, executing software instructions stored within the one or more memory units 110. In another example, process 1000 may be performed by the one or more processing modules 620. Process 1000 comprises: obtaining optical information (Step 710); determining if the number of people equals or exceeds a maximum threshold (Step 1020); providing indications (Step 1030). In some implementations, process 1000 may comprise one or more additional steps, while some of the steps listed above may be modified or excluded. Examples of possible execution manners of process 1000 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, the maximum threshold of Step 1020 may be selected to be any number of people. Examples of the maximum threshold of Step 1020 may include: zero persons; a single person; two people; three people; four people; at least five people; at least ten people; at least twenty people; at least fifty people; and so forth. In some cases, the maximum threshold of Step 1020 may be retrieved from the one or more memory units 110. In some cases, the maximum threshold of Step 1020 may be received through the one or more communication modules 130. In some cases, the maximum threshold of Step 1020 may be calculated, for example by the one or more processing units 120, by the one or more processing modules 620, and so forth.

In some embodiments, determining if the number of people equals or exceeds a maximum threshold (Step 1020) may comprise: obtaining an estimation of the number of people present (Step 920); and comparing the estimation of the number of people present in the environment obtained in Step 920 with the maximum threshold.

In some embodiments, determining if the number of people equals or exceeds a maximum threshold (Step 1020) may comprise determining if the number of people present in an environment equals or exceeds a maximum threshold based on the optical information. In some cases, detection algorithms may be applied on the optical information in order to detect people in the environment, the number of detected people may be counted in order to obtain an estimation of the number of people present in the environment, and the obtained estimated number of people may be compared with the maximum threshold. In other cases, determining if the number of people equals or exceeds a maximum threshold (Step 1020) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the number of people present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information. In some cases, determining if the number of people equals or exceeds a maximum threshold (Step 1020) may be based on one or more regression models. For example, the one or more regression models may be stored in a memory unit, such as the one or more memory units 110, and the regression models may be obtained by accessing the memory unit and reading the rules. For example, at least one of the one or more regression models may be preprogrammed manually. In another example, at least one of the one or more regression models may be the result of training machine learning algorithms on training examples, such as the training examples described above. In an additional example, at least one of the one or more regression models may be the result of deep learning algorithms. In another example, at least one of the one or more regression models may be based, at least in part, on the output of one or more neural networks, such as the output obtained by applying one or more neural networks on the optical information.

In some embodiments, determining if the number of people equals or exceeds a maximum threshold (Step 1020) may only consider people that meet specified criterions while ignoring all other people in the determination. For example: only people older than a certain age may be considered; only people younger than a certain age may be considered; only people of a certain gender may be considered; only people present in the environment for a period of time longer than a specified duration may be considered; only people from a list of specified persons may be considered; any combination of the above; and so forth.

In some embodiments, determining if the number of people equals or exceeds a maximum threshold (Step 1020) may ignore people that meet specified criterions. For example: people older than a certain age may be ignored; people younger than a certain age may be ignored; people of a certain gender may be ignored; people present in the environment for a period of time shorter than a specified duration may be ignored; people from a list of specified persons may be ignored; any combination of the above; and so forth.

In some embodiments, if it is determined that the number of people is lower than a maximum threshold (Step 1020: No), process 1000 may end. In other embodiments, if it is determined that the number of people is lower than a maximum threshold (Step 1020: No), process 1000 may return to Step 710. In some embodiments, if it is determined that the number of people is lower than a maximum threshold (Step 1020: No), other processes may be executed, such as process 700, process 800, process 900, process 1100, process 1200, process 1300, process 1400, process 1500, process 1600, process 1700, and so forth. In some embodiments, if it is determined that the number of people equals or exceeds a maximum threshold (Step 1020: Yes), process 1000 may provide indication (Step 1030).

In some embodiments, process 1000 may provide indication (Step 1030). In some examples, the indication that process 1000 provides in Step 1030 may be provided in the fashion described above. In some examples, an indication that the number of people equals or exceeds a maximum threshold may be provided. In some cases, information associated with the people present in the environment may be provided, as in Step 930. In some cases, the indication may be provided when properties associated with the detected people meet certain conditions. For instance, the information may be provided when the estimated number of people equals or exceeds a specified threshold for a period of time longer than a specified duration.

In some embodiments, a process for providing indications may comprise: obtaining optical information (Step 710); determining if the number of people equals or exceeds a maximum threshold (Step 1020); providing indications (Step 1030); obtaining an estimation of the number of people present (Step 920); providing information (Step 930). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

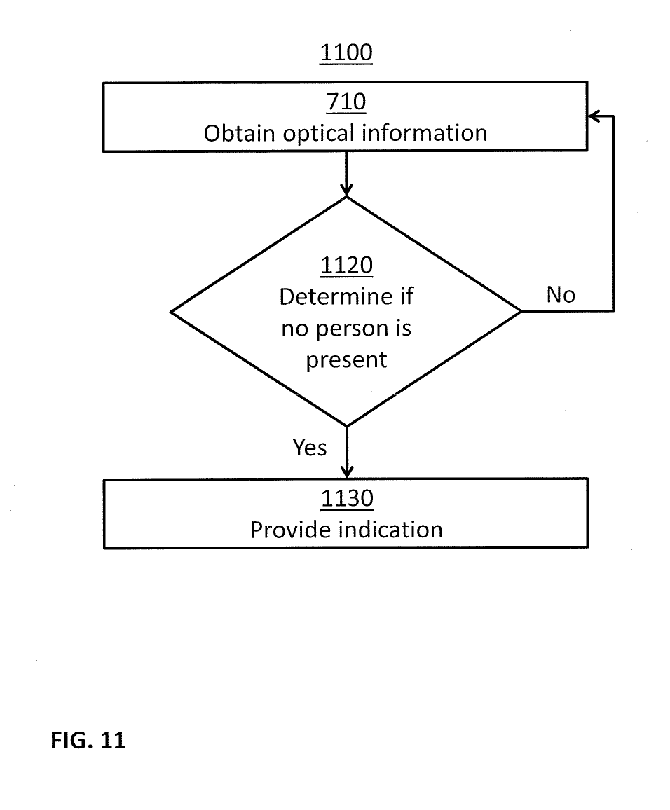

FIG. 11 illustrates an example of a process 1100 for providing indications. In some examples, process 1100, as well as all individual steps therein, may be performed by various aspects of: imaging apparatus 100; computing apparatus 500; and so forth. For example, process 1100 may be performed by the one or more processing units 120, executing software instructions stored within the one or more memory units 110. In another example, process 1100 may be performed by the one or more processing modules 620. Process 1100 comprises: obtaining optical information (Step 710); determining if no person is present (Step 1120); providing indications (Step 1130). In some implementations, process 1100 may comprise one or more additional steps, while some of the steps listed above may be modified or excluded. Examples of possible execution manners of process 1100 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, determining if no person is present (Step 1120) may comprise: obtaining an estimation of the number of people present (Step 920); and checking if the estimation of the number of people present in the environment obtained in Step 920 is zero.

In some embodiments, determining if no person is present (Step 1120) may comprise determining if there is no person present in the environment based on the optical information. In some cases, detection algorithms may be applied on the optical information in order to detect people in the environment, and it is determined that there is no person present in the environment if no person is detected. In other cases, determining if no person is present (Step 1120) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the number of people present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, determining if no person is present (Step 1120) may only consider people that meet specified criterions while ignoring all other people in the determination. For example: only people older than a certain age may be considered; only people younger than a certain age may be considered; only people of a certain gender may be considered; only people present in the environment for a period of time longer than a specified duration may be considered; only people from a list of specified persons may be considered; any combination of the above; and so forth.

In some embodiments, determining if no person is present (Step 1120) may ignore people that meet specified criterions. For example: people older than a certain age may be ignored; people younger than a certain age may be ignored; people of a certain gender may be ignored; people present in the environment for a period of time shorter than a specified duration may be ignored; people from a list of specified persons may be ignored; any combination of the above; and so forth.

In some embodiments, if it is determined that people are present in the environment (Step 1120: No), process 1100 may end. In other embodiments, if it is determined that people are present in the environment (Step 1120: No), process 1100 may return to Step 710. In some embodiments, if it is determined that people are present in the environment (Step 1120: No), other processes may be executed, such as process 700, process 800, process 900, process 1000, process 1200, process 1300, process 1400, process 1500, process 1600, process 1700, and so forth. In some embodiments, if it is determined that there is no person present in the environment (Step 1120: Yes), process 1100 may provide indication (Step 1130).

In some embodiments, process 1100 may provide indication (Step 1130). In some examples, the indication that process 1100 provides in Step 1130 may be provided in the fashion described above. In some examples, an indication that there is no person present in the environment may be provided. In some cases, information associated with the determination that there is no person present in the environment may be provided. In some cases, the indication may include information associated with: the duration of time in which there is no person was present in the environment. In some cases, the indication may be provided when properties associated with the determination that there is no person present in the environment meet certain conditions. For instance, the information may be provided when there is no person present in the environment for a period of time longer than a specified duration.

In some embodiments, a process for providing indications may comprise: obtaining optical information (Step 710); determining if the number of people equals or exceeds a maximum threshold (Step 1020); providing indications (Step 1030); determining if no person is present (Step 1120); providing indications (Step 1130). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

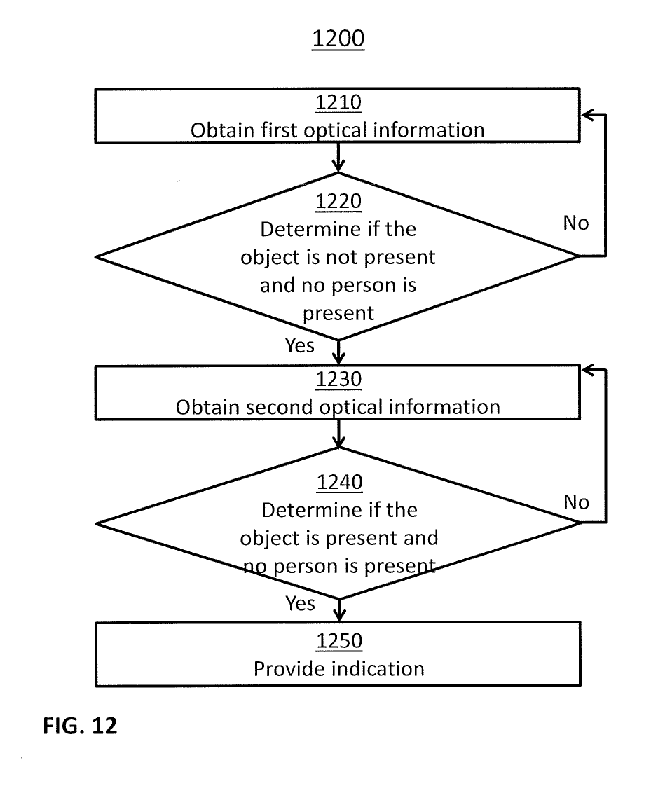

FIG. 12 illustrates an example of a process 1200 for providing indications. In some examples, process 1200, as well as all individual steps therein, may be performed by various aspects of: imaging apparatus 100; computing apparatus 500; and so forth. For example, process 1200 may be performed by the one or more processing units 120, executing software instructions stored within the one or more memory units 110. In another example, process 1200 may be performed by the one or more processing modules 620. Process 1200 comprises: obtaining first optical information (Step 1210); determining if the object is not present and no person is present (Step 1220); obtaining second optical information (Step 1230); determining if the object is present and no person is present (Step 1240); providing indications (Step 1250). In some implementations, process 1200 may comprise one or more additional steps, while some of the steps listed above may be modified or excluded. Examples of possible execution manners of process 1200 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, obtaining first optical information (Step 1210) and obtaining second optical information (Step 1230) may be implemented in a similar fashion to obtaining optical information (Step 710). The second optical information, obtained by Step 1230, is from a later point in time of the first optical information, obtained by Step 1210.

In some embodiments, determining if the object is not present and no person is present (Step 1220) for a specific object may comprise: determining if no person is present (Step 1120); determining if an item is present (Step 720), where the item is the specific object; and determining that the specific object is not present and no person is present if and only if Step 1120 determined that no person is present and Step 720 determined that the specified object is not present.

In some embodiments, determining if the object is not present and no person is present (Step 1220) may comprise determining if the object is not present in the environment and no person is present in the environment based on optical information. In some cases, detection algorithms may be applied on optical information in order to detect people in the environment and to detect objects in the environment, and it is determined that the object is not present and no person is present if no person is detected and the object is not detected. In other cases, determining if the object is not present and no person is present (Step 1220) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the number of people present in the environment and the objects present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, determining if the object is present and no person is present (Step 1240) for a specific object may comprise: determining if no person is present (Step 1120); determining if an item is present (Step 720), where the item is the specific object; and determining that the specific object is present and no person is present if Step 1120 determined that no person is present and Step 720 determined that the specified object is present.

In some embodiments, determining if the object is present and no person is present (Step 1240) may comprise determining if the object is present in the environment and no person is present in the environment based on optical information. In some cases, detection algorithms may be applied on optical information in order to detect people in the environment and to detect objects in the environment, and it is determined that the object is present and no person is present if no person is detected while the object is detected. In other cases, determining if the object is present and no person is present (Step 1240) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the number of people present in the environment and the objects present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, determining if the object is not present and no person is present (Step 1220) and/or determining if the object is present and no person is present (Step 1240) may only consider people that meet specified criterions while ignoring all other people in the determination. For example: only people older than a certain age may be considered; only people younger than a certain age may be considered; only people of a certain gender may be considered; only people present in the environment for a period of time longer than a specified duration may be considered; only people from a list of specified persons may be considered; any combination of the above; and so forth.

In some embodiments, determining if the object is not present and no person is present (Step 1220) and/or determining if the object is present and no person is present (Step 1240) may ignore people that meet specified criterions. For example: people older than a certain age may be ignored; people younger than a certain age may be ignored; people of a certain gender may be ignored; people present in the environment for a period of time shorter than a specified duration may be ignored; people from a list of specified persons may be ignored; any combination of the above; and so forth.

In some embodiments, process 1200 may provide indication (Step 1250). In some examples, the indication that process 1200 provides in Step 1250 may be provided in the fashion described above. In some examples, an indication that an object is present and no person is present after the object was not present and no person was present may be provided. In some cases, the indication may include information associated with: the type of the object; properties of the object; the point in time at which the object was first present in the environment; identities of people associated with the object; properties of people associated with the object; and so forth. In some cases, the indication may be provided when properties associated with the determination that an object is present and no person is present after the object was not present and no person was present meet certain conditions. For instance, the information may be provided: when the type of the object is of a list of specified types; when the size of the object is at least a minimal size; and so forth.

In some embodiments, in process 1200: determine if the object is not present and no person is present (Step 1220) is performed using the first optical information obtained in Step 1210; determining if the object is present and no person is present (Step 1240) is performed using the second optical information obtained in Step 1230; and the first optical information is associated with a point of time prior to the point of time associated with the second optical information.

In some embodiments, process 1200 flow is as follows: After obtaining first optical information (Step 1210), process 1200 follows to determine if the object is not present and no person is present (Step 1220). Based on the result of Step 1220, the process may continue by obtaining second optical information (Step 1230); followed by determining if the object is present and no person is present (Step 1240). Based on the result of Step 1240, process 1200 may provide indication (Step 1250).

In some embodiments, process 1200 flow is as follows: After obtaining first optical information (Step 1210), process 1200 follows to obtain second optical information (Step 1230). Then, process 1200 may determine if the object is not present and no person is present (Step 1220). Based on the result of Step 1220, the process may continue by determining if the object is present and no person is present (Step 1240). Based on the result of Step 1240, process 1200 may provide indication (Step 1250).

In some embodiments, process 1200 flow is as follows: After obtaining first optical information (Step 1210) and obtaining second optical information (Step 1230), process 1200 may determine if the object is not present and no person is present (Step 1220). Based on the result of Step 1220, the process may continue by determining if the object is present and no person is present (Step 1240). Based on the result of Step 1240, process 1200 may provide indication (Step 1250).

In some embodiments, process 1200 flow is as follows: After obtaining first optical information (Step 1210) and obtaining second optical information (Step 1230), process 1200 may determine if the object is not present and no person is present (Step 1220) and determine if the object is present and no person is present (Step 1240). Based on the result of Step 1220 and the result of Step 1240, process 1200 may provide indication (Step 1250).

In some embodiments, process 1200 flow is as follows: After obtaining first optical information (Step 1210) and obtaining second optical information (Step 1230), process 1200 may determine if the object is present and no person is present (Step 1240). Based on the result of Step 1240, the process may continue by determining if the object is not present and no person is present (Step 1220). Based on the result of Step 1220, process 1200 may provide indication (Step 1250).

In some embodiments, if it is determined that the object is present and/or a person is present (Step 1220: No), process 1200 may end. In other embodiments, if it is determined that the object is present and/or a person is present (Step 1220: No), process 1200 may return to Step 1210. In some embodiments, if it is determined that the object is present and/or a person is present (Step 1220: No), other processes may be executed, such as process 700, process 800, process 900, process 1000, process 1100, process 1300, process 1400, process 1500, process 1600, process 1700, and so forth. In some embodiments, if it is determined that the object is not present and no person is present (Step 1220: Yes), process 1200 may follow to Step 1230, and then follow to Step 1240. In some embodiments, if it is determined that the object is not present and no person is present (Step 1220: Yes), process 1200 may follow to a following step.

In some embodiments, if it is determined that the object is not present and/or a person is present (Step 1240: No), process 1200 may end. In other embodiments, if it is determined that the object is not present and/or a person is present (Step 1240: No), process 1200 may return to a prior step. In some embodiments, if it is determined that the object is not present and/or a person is present (Step 1240: No), other processes may be executed, such as process 700, process 800, process 900, process 1000, process 1100, process 1300, process 1400, process 1500, process 1600, process 1700, and so forth. In some embodiments, if it is determined that the object is present and no person is present (Step 1240: Yes), process 1200 may follow to a following step.

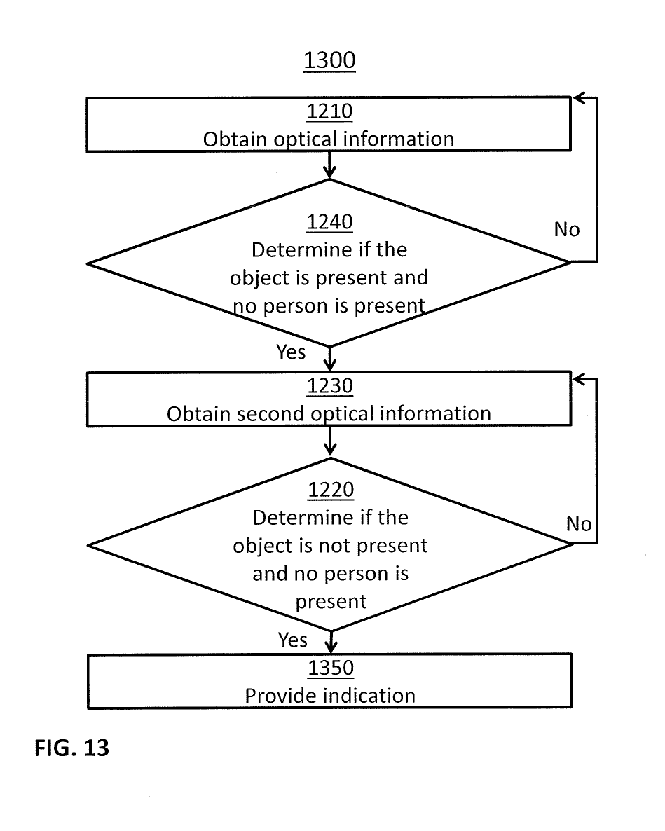

FIG. 13 illustrates an example of a process 1300 for providing indications. In some examples, process 1300, as well as all individual steps therein, may be performed by various aspects of: imaging apparatus 100; computing apparatus 500; and so forth. For example, process 1300 may be performed by the one or more processing units 120, executing software instructions stored within the one or more memory units 110. In another example, process 1300 may be performed by the one or more processing modules 620. Process 1300 comprises: obtaining first optical information (Step 1210); determining if the object is present and no person is present (Step 1240); obtaining second optical information (Step 1230); determining if the object is not present and no person is present (Step 1220); providing indications (Step 1350). In some implementations, process 1300 may comprise one or more additional steps, while some of the steps listed above may be modified or excluded. Examples of possible execution manners of process 1300 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, process 1300 may provide indication (Step 1350). In some examples, the indication that process 1300 provides in Step 1350 may be provided in the fashion described above. In some examples, an indication that an object is not present and no person is present after the object was present and no person was present may be provided. In some cases, the indication may include information associated with: the type of the object; properties of the object; the point in time at which the object was first missing from the environment; identities of people associated with the object; properties of people associated with the object; and so forth. In some cases, the indication may be provided when properties associated with the determination that an object is not present and no person is present after the object was present and no person was present meet certain conditions. For instance, the information may be provided: when the type of the object is of a list of specified types; when the size of the object is at least a minimal size; and so forth.

In some embodiments, in process 1300: determining if the object is present and no person is present (Step 1240) is performed using the first optical information obtained in Step 1210; determining if the object is not present and no person is present (Step 1220) is performed using the second optical information obtained in Step 1230; and the first optical information is associated with a point of time prior to the point of time associated with the second optical information.

In some embodiments, process 1300 flow is as follows: After obtaining first optical information (Step 1210), process 1300 follows to determine if the object is present and no person is present (Step 1240). Based on the result of Step 1240, the process may continue by obtaining second optical information (Step 1230); followed by determining if the object is not present and no person is present (Step 1220). Based on the result of Step 1220, process 1300 may provide indication (Step 1350).

In some embodiments, process 1300 flow is as follows: After obtaining first optical information (Step 1210), process 1300 follows to obtain second optical information (Step 1230). Then, process 1300 may determine if the object is present and no person is present (Step 1240). Based on the result of Step 1240, the process may continue by determining if the object is not present and no person is present (Step 1220). Based on the result of Step 1220, process 1300 may provide indication (Step 1350).

In some embodiments, process 1300 flow is as follows: After obtaining first optical information (Step 1210) and obtaining second optical information (Step 1230), process 1300 may determine if the object is present and no person is present (Step 1240). Based on the result of Step 1240, the process may continue by determining if the object is not present and no person is present (Step 1220). Based on the result of Step 1220, process 1300 may provide indication (Step 1350).

In some embodiments, process 1300 flow is as follows: After obtaining first optical information (Step 1210) and obtaining second optical information (Step 1230), process 1300 may determine if the object is not present and no person is present (Step 1220). Based on the result of Step 1220, the process may continue by determining if the object is present and no person is present (Step 1240). Based on the result of Step 1240, process 1300 may provide indication (Step 1350).

In some embodiments, process 1300 flow is as follows: After obtaining first optical information (Step 1210) and obtaining second optical information (Step 1230), process 1300 may determine if the object is present and no person is present (Step 1240) and determine if the object is not present and no person is present (Step 1220). Based on the result of Step 1240 and the result of Step 1220, process 1200 may provide indication (Step 1350).

In some embodiments, if it is determined that the object is not present and/or a person is present (Step 1240: No), process 1300 may end. In other embodiments, if it is determined that the object is not present and/or a person is present (Step 1240: No), process 1300 may return to Step 1210. In some embodiments, if it is determined that the object is not present and/or a person is present (Step 1240: No), other processes may be executed, such as process 700, process 800, process 900, process 1000, process 1100, process 1200, process 1400, process 1500, process 1600, process 1700, and so forth. In some embodiments, if it is determined that the object is present and no person is present (Step 1240: Yes), process 1300 may follow to Step 1230, and then follow to Step 1220. In some embodiments, if it is determined that the object is present and no person is present (Step 1240: Yes), process 1300 may follow to a following step.

In some embodiments, if it is determined that the object is present and/or a person is present (Step 1220: No), process 1300 may end. In other embodiments, if it is determined that the object is present and/or a person is present (Step 1220: No), process 1300 may return to a prior step. In some embodiments, if it is determined that the object is present and/or a person is present (Step 1220: No), other processes may be executed, such as process 700, process 800, process 900, process 1000, process 1100, process 1200, process 1400, process 1500, process 1600, process 1700, and so forth. In some embodiments, if it is determined that the object is not present and no person is present (Step 1220: Yes), process 1300 may follow to a following step.

In some embodiments, a process for providing indications may comprise: obtaining optical information (Step 710); determining if the number of people equals or exceeds a maximum threshold (Step 1020); providing indications (Step 1030); obtaining second optical information (Step 1230); determining if the object is not present and no person is present (Step 1220); and determining if the object is present and no person is present (Step 1240). The process may also comprise: providing indications (Step 1250) and/or providing indications (Step 1350). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

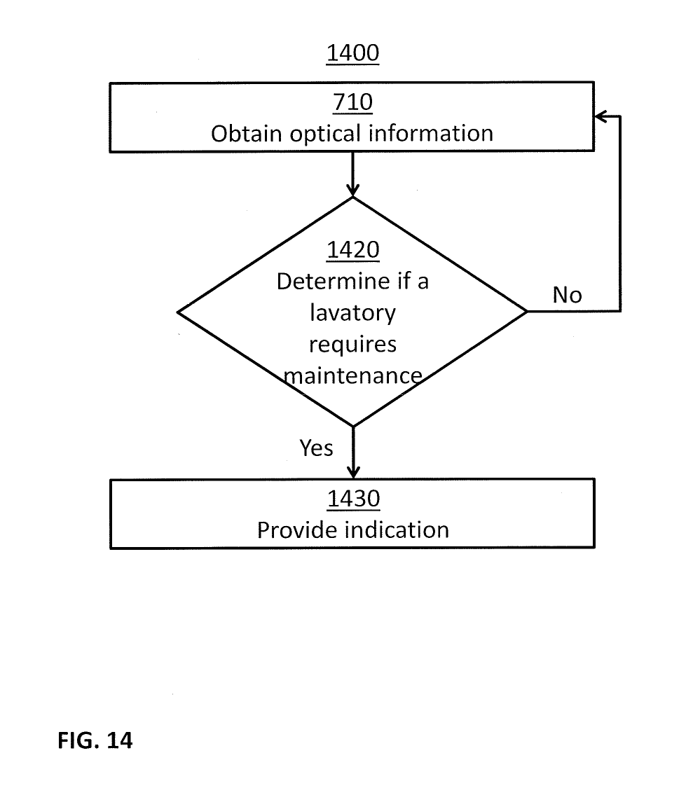

FIG. 14 illustrates an example of a process 1400 for providing indications. In some examples, process 1400, as well as all individual steps therein, may be performed by various aspects of: imaging apparatus 100; computing apparatus 500; and so forth. For example, process 1400 may be performed by the one or more processing units 120, executing software instructions stored within the one or more memory units 110. In another example, process 1400 may be performed by the one or more processing modules 620. Process 1400 comprises: obtaining optical information (Step 710); determining if a lavatory requires maintenance (Step 1420); providing indications (Step 1430). In some implementations, process 1400 may comprise one or more additional steps, while some of the steps listed above may be modified or excluded. Examples of possible execution manners of process 1400 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, determining if a lavatory requires maintenance (Step 1420) may comprise determining if a lavatory requires maintenance based on the optical information. In some cases, detection algorithms may be applied on the optical information in order to detect a malfunction in the environment, and it is determined that the lavatory requires maintenance if a malfunction is detected. Examples of malfunctions may include: a flooding lavatory; a water leak; a malfunctioning light bulb; a malfunction in the lavatory flushing system; and so forth. In some cases, detection algorithms may be applied on the optical information in order to detect a full garbage can and/or a nearly full garbage can in the environment, and it is determined that the lavatory requires maintenance if a full garbage can and/or a nearly full garbage can is detected. In some cases, detection algorithms may be applied on the optical information in order to detect in the environment an empty and/or a nearly empty container that needs restocking, and it is determined that the lavatory requires maintenance if an empty and/or a nearly empty container that needs restocking is detected. Examples of containers that may need restocking include: soap dispenser; toilet paper dispenser; paper towels dispenser; paper cup dispenser; hand-cream dispenser; tissue dispenser; napkins dispenser; air sickness bags dispenser; motion sickness bags dispenser; and so forth. In some cases, detection algorithms may be applied on the optical information in order to detect unclean lavatory in the environment, and it is determined that the lavatory requires maintenance if an unclean lavatory is detected. In some cases, detection algorithms may be applied on the optical information in order to detect physically broken equipment in the environment, and it is determined that the lavatory requires maintenance if a physically broken equipment is detected. In some cases, detection algorithms may be applied on the optical information in order to detect paintings in the environment, and it is determined that the lavatory requires maintenance if an undesired painting is detected.

In some embodiments, determining if a lavatory requires maintenance (Step 1420) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the state of the lavatory. For example, the optical information instance may be labeled according to the existence of a malfunction at the time the optical information was captured. Examples of malfunctions may include: a flooding lavatory; a water leak; a malfunctioning light bulb; a malfunction in the lavatory flushing system; and so forth. For example, the optical information instance may be labeled according to the existence of a full garbage can and/or a nearly full garbage can at the time the optical information was captured. For example, the optical information instance may be labeled according to the cleanliness status of the lavatory at the time the optical information was captured. For example, the optical information instance may be labeled according to the status of the equipment and/or the presence of physically broken equipment at the time the optical information was captured. For example, the optical information instance may be labeled according to the existence of an undesired painting at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, if it is determined that a lavatory does not require maintenance (Step 1420: No), process 1400 may end. In other embodiments, if it is determined that a lavatory does not require maintenance (Step 1420: No), process 1400 may return to Step 710. In some embodiments, if it is determined that a lavatory does not require maintenance (Step 1420: No), other processes may be executed, such as process 700, process 800, process 900, process 1000, process 1100, process 1200, process 1300, process 1500, process 1600, process 1700, and so forth. In some embodiments, if it is determined that a lavatory requires maintenance (Step 1420: Yes), process 1400 may provide indication (Step 1430).

In some embodiments, process 1400 may provide indication (Step 1430). In some examples, the indication that process 1400 provides in Step 1430 may be provided in the fashion described above. In some examples, an indication that a lavatory requires maintenance may be provided. In some cases, information associated with the determination that a lavatory requires maintenance may be provided. In some cases, the indication may include information associated with: the type of maintenance required; the reason the maintenance is required; the time passed since the determination that a lavatory requires maintenance was first made; and so forth. In some cases, the indication may be provided when properties associated with the determination that a lavatory requires maintenance meet certain conditions. For instance, the information may be provided: when the time passed since the determination that a lavatory requires maintenance was first made is lower than or above a certain threshold; when the type of maintenance required is of a list of specified types; and so forth.

In some embodiments, a process for providing indications may comprise: obtaining optical information (Step 710); determining if the number of people equals or exceeds a maximum threshold (Step 1020); providing indications (Step 1030); determining if a lavatory requires maintenance (Step 1420); providing indications (Step 1430). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

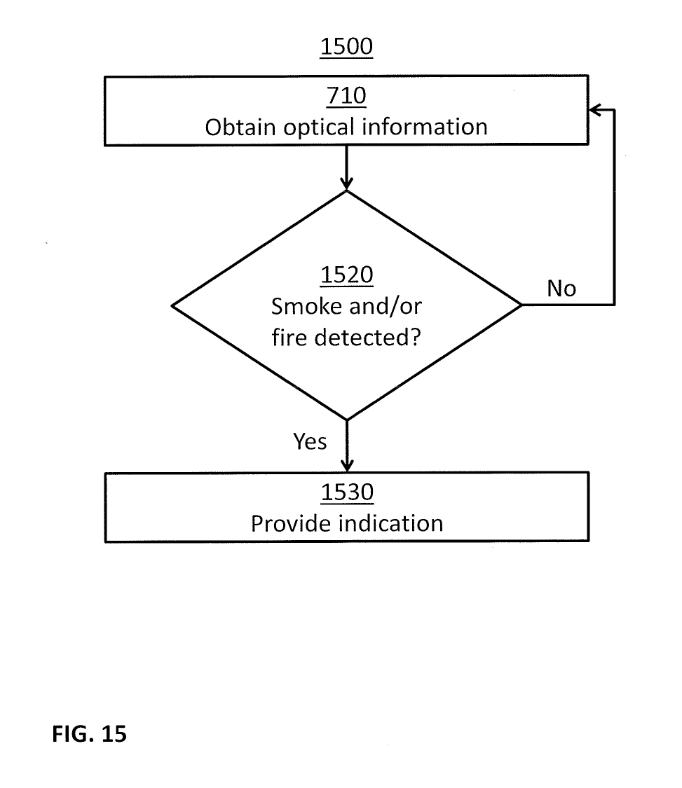

FIG. 15 illustrates an example of a process 1500 for providing indications. In some examples, process 1500, as well as all individual steps therein, may be performed by various aspects of: imaging apparatus 100; computing apparatus 500; and so forth. For example, process 1500 may be performed by the one or more processing units 120, executing software instructions stored within the one or more memory units 110. In another example, process 1500 may be performed by the one or more processing modules 620. Process 1500 comprises: obtaining optical information (Step 710); detecting smoke and/or fire (Step 1520); providing indications (Step 1530). In some implementations, process 1500 may comprise one or more additional steps, while some of the steps listed above may be modified or excluded. Examples of possible execution manners of process 1500 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, detecting smoke and/or fire (Step 1520) may comprise detecting smoke and/or fire in the environment based on the optical information. In some cases, detecting smoke and/or fire (Step 1520) may also be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; some optical information instances captured when smoke and/or fire are present and labeled accordingly; while other optical information instances captured when smoke and/or fire are not present and labeled accordingly. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, if smoke and/or fire are not detected (Step 1520: No), process 1500 may end. In other embodiments, if smoke and/or fire are not detected (Step 1520: No), process 1500 may return to Step 710. In some embodiments, if smoke and/or fire are not detected (Step 1520: No), other processes may be executed, such as process 700, process 800, process 900, process 1000, process 1100, process 1200, process 1300, process 1400, process 1600, process 1700, and so forth. In some embodiments, if smoke and/or fire are detected (Step 1520: Yes), process 1500 may provide indications (Step 1530).

In some embodiments, process 1500 may provide indications (Step 1530). In some embodiments, the indication that process 1500 provides in Step 1530 may be provided in the fashion described above. In some examples, an indication associated with the detected smoke and/or fire may be provided. In some cases, the indication may also include information associated with: one or more locations associated with the detected smoke and/or fire; the amount of smoke and/or fire detected; the time smoke and/or fire was first detected; and so forth. In some cases, the indication may be provided when properties associated with the detected smoke and/or fire meet certain conditions. For instance, an indication may be provided: when the smoke and/or fire are detected for a time duration longer than a specified threshold; when the amount of smoke and/or fire detected is above a specified threshold; and so forth.

In some embodiments, a process for providing indications may comprise: obtaining optical information (Step 710); determining if an item is present (Step 720); providing indications (Step 730); detecting smoke and/or fire (Step 1520); providing indications associated with the detected smoke and/or fire (Step 1530). In some implementations, the process may comprise one or more additional steps, while some of the steps listed above may be modified or excluded. In some examples, the process, as well as all individual steps therein, may be performed by various aspects of: imaging apparatus 100; computing apparatus 500; and so forth. For example, the process may be performed by the one or more processing units 120, executing software instructions stored within the one or more memory units 110. In another example, the process may be performed by the one or more processing modules 620. Examples of possible execution manners of the process may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

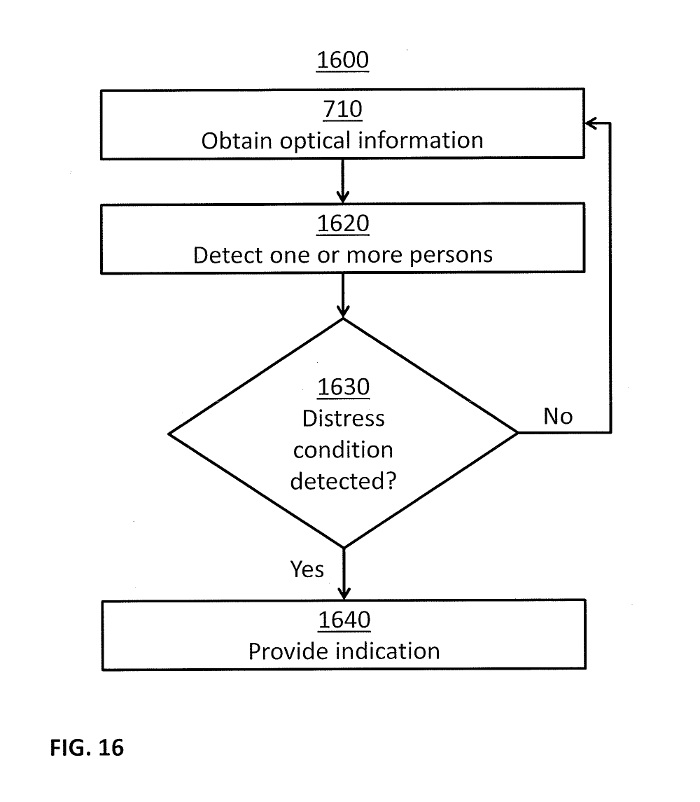

FIG. 16 illustrates an example of a process 1600 for providing indications. In some examples, process 1600, as well as all individual steps therein, may be performed by various aspects of: imaging apparatus 100; computing apparatus 500; and so forth. For example, process 1600 may be performed by the one or more processing units 120, executing software instructions stored within the one or more memory units 110. In another example, process 1600 may be performed by the one or more processing modules 620. Process 1600 comprises: obtaining optical information (Step 710); detecting one or more persons (Step 1620); detecting a distress condition (Step 1630); providing indications (Step 1640). In some implementations, process 1600 may comprise one or more additional steps, while some of the steps listed above may be modified or excluded. Examples of possible execution manners of process 1600 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, detecting one or more persons (Step 1620) may comprise: obtaining an estimation of the number of people present (Step 920); and checking if the estimation of the number of people present in the environment obtained in Step 920 is at least one.

In some embodiments, detecting one or more persons (Step 1620) may comprise: detecting one or more people in the environment based on the optical information. In some cases, detection algorithms may be applied on the optical information in order to detect people in the environment. In other cases, detecting one or more persons (Step 1620) may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; each optical information instance may be labeled according to the people present in the environment at the time the optical information was captured. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, detecting a distress condition (Step 1630) may comprise: determining if an event occurred (Step 820) for events that are associated with a distress condition, and determining that a distress condition detected if Step 820 determines that events that are associated with a distress condition occurred. Possible examples of events that are associated with a distress condition include: a person that does not move for a time period longer than a given time length; a person that does not breathe for a time period longer than a given time length; a person that collapses; a person that falls; a person lying down on the floor; two or more people involved in a fight; a person bleeding; a person being injured; and so forth.

In some embodiments, detecting a distress condition (Step 1630) may comprise detecting a distress condition in the environment based on the optical information. In some cases, detecting a distress condition (Step 1630) may also be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; some optical information instances captured when distress conditions are present and labeled accordingly; while other optical information instances captured when distress conditions are not present and labeled accordingly. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, if a distress condition is not detected (Step 1630: No), process 1600 may end. In other embodiments, if a distress condition is not detected (Step 1630: No), process 1600 may return to Step 710. In some embodiments, if a distress condition is not detected (Step 1630: No), other processes may be executed, such as process 700, process 800, process 900, process 1000, process 1100, process 1200, process 1300, process 1400, process 1500, process 1700, and so forth. In some embodiments, if a distress condition is detected (Step 1630: Yes), process 1600 may provide indications (Step 1640).

In some embodiments, process 1600 may provide indications (Step 1640). In some examples, the indication that process 1600 provides in Step 1640 may be provided in the fashion described above. In some examples, an indication associated with the detected distress condition may be provided. In some cases, the indication may also include information associated with: one or more locations associated with the detected distress condition; the type of the distress condition; the time the distress condition was first detected; and so forth. In some cases, the indication may be provided when properties associated with the detected distress condition meet certain conditions. For instance, an indication may be provided: when the distress condition is detected for time duration longer than a specified threshold; when the type of the detected distress condition is of a list specified types; and so forth.

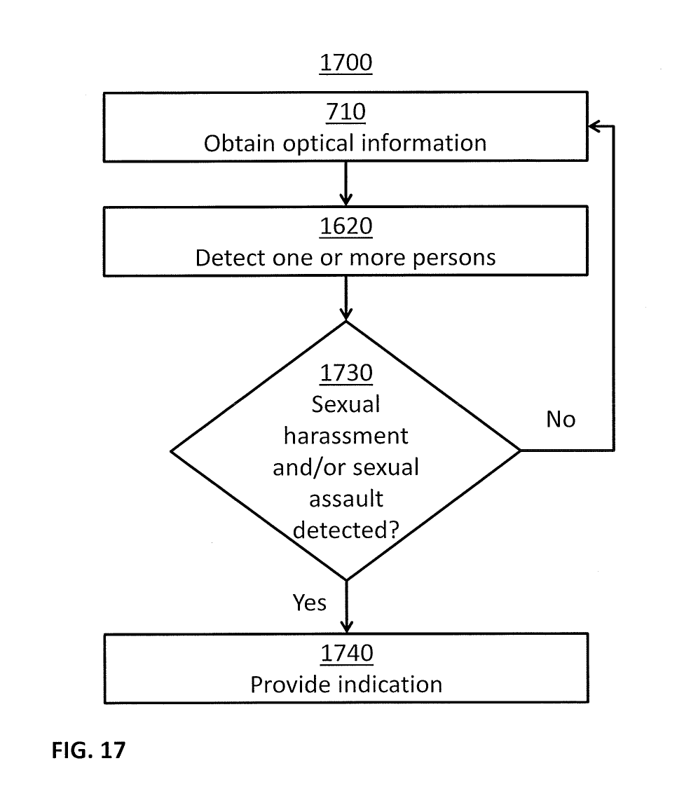

FIG. 17 illustrates an example of a process 1700 for providing indications. In some examples, process 1700, as well as all individual steps therein, may be performed by various aspects of: imaging apparatus 100; computing apparatus 500; and so forth. For example, process 1700 may be performed by the one or more processing units 120, executing software instructions stored within the one or more memory units 110. In another example, process 1700 may be performed by the one or more processing modules 620. Process 1700 comprises: obtaining optical information (Step 710); detecting one or more persons (Step 1620); detecting a sexual harassment and/or a sexual assault (Step 1730); providing indications (Step 1740). In some implementations, process 1700 may comprise one or more additional steps, while some of the steps listed above may be modified or excluded. Examples of possible execution manners of process 1700 may include: continuous execution, returning to the beginning of the process once the process normal execution ends; periodically execution, executing the process at selected times; execution upon the detection of a trigger, where examples of such trigger may include trigger from a user, trigger from another process, etc.; any combination of the above; and so forth.

In some embodiments, detecting a sexual harassment and/or a sexual assault (Step 1730) may comprise: determining if an event occurred (Step 820) for events that are associated with a sexual harassment and/or a sexual assault, and determining that a sexual harassment and/or a sexual assault detected if Step 820 determines that events that is associated with a sexual harassment and/or a sexual assault occurred. Possible examples of events that are associated with a sexual harassment and/or a sexual assault include: a person touching another person inappropriately; a person forcing another person to perform sexual act; a person forcing another person to look at sexually explicit material; a person forcing another person to pose in a sexually explicit way; a health care professional giving unnecessary internal examination to a patient or touching a patient inappropriately; a sexual act performed at an inappropriate location, such as a lavatory, a school, a kindergarten, a playground, a healthcare facility, a hospital, a doctor office, etc.; and so forth.

In some embodiments, detecting a sexual harassment and/or a sexual assault (Step 1730) may comprise detecting a sexual harassment and/or a sexual assault in the environment based on the optical information. In some cases, detecting a sexual harassment and/or a sexual assault (Step 1730) may also be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances; some optical information instances captured when a sexual harassment and/or a sexual assault are taking place and labeled accordingly; while other optical information instances captured when a sexual harassment and/or a sexual assault are not taking place and labeled accordingly. In an additional example, at least one of the one or more decision rules may be the result of deep learning algorithms. In another example, at least one of the one or more decision rules may be based, at least in part, on the output of one or more neural networks, such as the output obtained by applying one or more neural networks on the optical information.

In some embodiments, if a sexual harassment and/or a sexual assault are not detected (Step 1730: No), process 1700 may end. In other embodiments, if a sexual harassment and/or a sexual assault are not detected (Step 1730: No), process 1700 may return to Step 710. In some embodiments, if a sexual harassment and/or a sexual assault are not detected (Step 1730: No), other processes may be executed, such as process 700, process 800, process 900, process 1000, process 1100, process 1200, process 1300, process 1400, process 1500, process 1600, and so forth. In some embodiments, if a sexual harassment and/or a sexual assault are detected (Step 1730: Yes), process 1700 may provide indication associated with the detected sexual harassment and/or sexual assault (Step 1740).

In some embodiments, process 1700 may provide indications (Step 1740). In some examples, the indications that process 1700 provides in Step 1740 may be provided in the fashion described above. In some examples, an indication associated with the detected sexual harassment and/or sexual assault may be provided. In some cases, the indication may also include information associated with: one or more locations associated with the detected sexual harassment and/or sexual assault; the type of the sexual harassment and/or sexual assault; the time the sexual harassment and/or sexual assault was first detected; and so forth. In some cases, the indication may be provided when properties associated with the detected sexual harassment and/or sexual assault meet certain conditions. For instance, an indication may be provided: when the sexual harassment and/or sexual assault is detected for a time duration longer than a specified threshold; when the type of the detected sexual harassment and/or sexual assault is of a list specified types; and so forth.

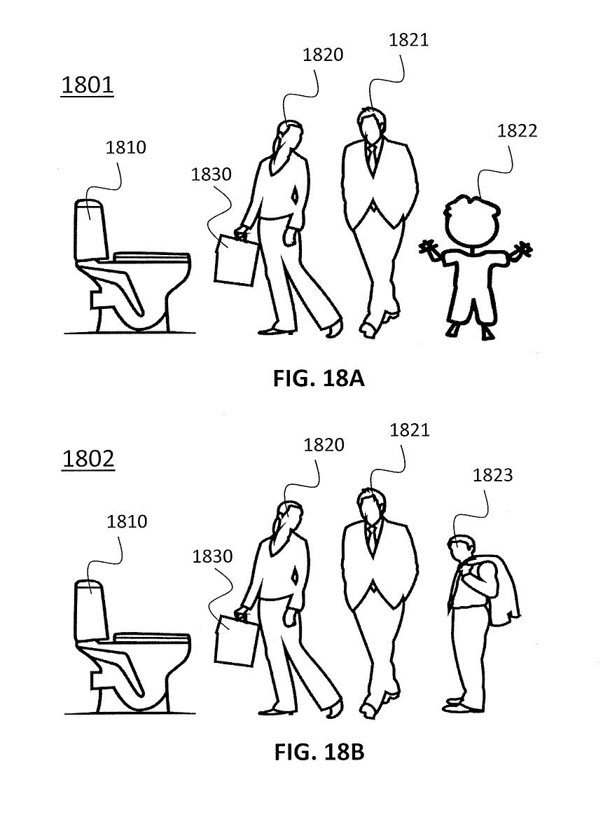

FIG. 18A is a schematic illustration of an example of an environment 1801. In this example, environment 1801 is an environment in a lavatory. In this example, environment 1801 comprises: lavatory equipment 1810; an adult woman 1820; an adult man 1821; a child 1822; and an object 1830. Person 1820 holds object 1830.

FIG. 18B is a schematic illustration of an example of an environment 1802. In this example, environment 1802 is an environment in a lavatory. In this example, environment 1802 comprises: lavatory equipment 1810; an adult woman 1820; an adult man 1821; an adult man of short stature 1823; and an object 1830. In this example, the adult woman 1820 holds object 1830.

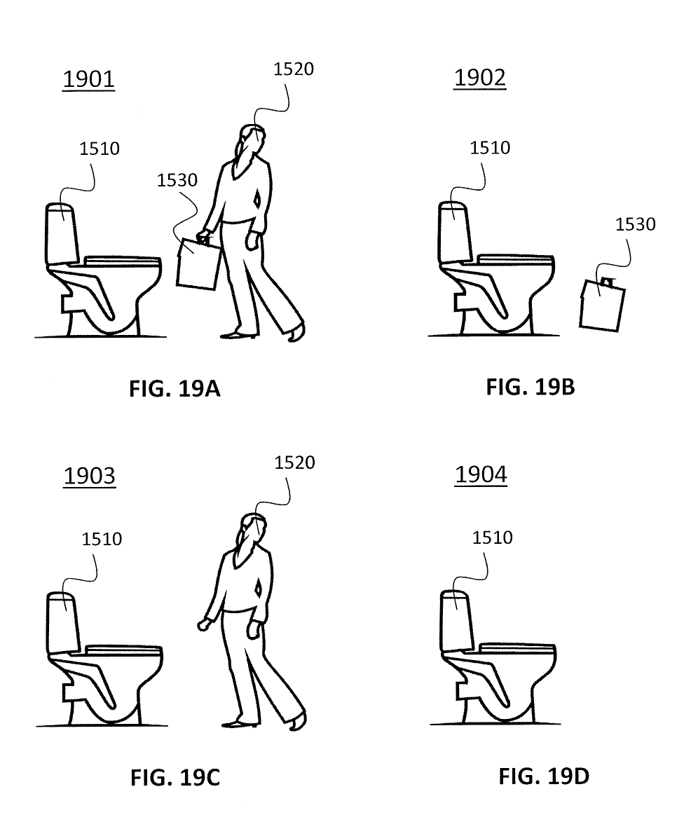

FIG. 19A is a schematic illustration of an example of an environment 1901. In this example, environment 1901 is an environment in a lavatory. In this example, environment 1901 comprises: lavatory equipment 1810; an adult woman 1820; and an object 1830. In this example, the adult woman 1820 holds object 1830.

FIG. 19B is a schematic illustration of an example of an environment 1902. In this example, environment 1902 is an environment in a lavatory. In this example, environment 1902 comprises: lavatory equipment 1810; and an object 1830.

FIG. 19C is a schematic illustration of an example of an environment 1903. In this example, environment 1903 is an environment in a lavatory. In this example, environment 1903 comprises: lavatory equipment 1810; and an adult woman 1820.

FIG. 19D is a schematic illustration of an example of an environment 1904. In this example, environment 1904 is an environment in a lavatory. In this example, environment 1904 comprises lavatory equipment 1810.

In some embodiments, lavatory equipment 1810 may include any equipment usually found in a lavatory. Examples of such equipment may include one or more of: toilets; toilet seats; bidets; urinals; sinks; basins; mirrors; furniture; cabinets; towel bars; towel rings; towel warmers; bathroom accessories; rugs; garbage cans; doors; windows; faucets; soap treys; shelves; cleaning equipment; ashtrays; emergency call buttons; electrical outlets; safety equipment; signs; soap dispenser; toilet paper dispenser; paper towels dispenser; paper cup dispenser; hand-cream dispenser; tissue dispenser; napkins dispenser; air sickness bags dispenser; motion sickness bags dispenser; and so forth.

In some embodiments, optical information may be obtained from an environment of a lavatory. For example, the optical information may be captured from an environment of a lavatory: using the one or more image sensors 150; using one or more imaging apparatuses, an example of an implementation of such imaging apparatus is imaging apparatus 100; using monitoring system 600; and so forth. In some embodiments, the optical information obtained from an environment of a lavatory may be processes, analyzed and/or monitored. For example, the optical information may be obtained from an environment of a lavatory and may be processed, analyzed and/or monitored: using one or more processing units 120; using imaging apparatus 100; using computing apparatus 500; using monitoring system 600; and so forth. For example, the optical information may be obtained from an environment of a lavatory may be processes, analyzed and/or monitored using: process 700; process 800; process 900; process 1000; process 1100; process 1200; process 1300; process 1400; process 1500; process 1600; process 1700; any combination of the above; and so forth.

In some embodiments, optical information may be obtained from an environment of a lavatory of an airplane. In some examples, indications and information based on the optical information obtained from an environment of a lavatory of an airplane may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of an airplane may be provided to: one or more members of the aircrew; one or more members of the ground crew; one or more members of the control tower crew; security personnel; and so forth.

In some embodiments, optical information may be obtained from an environment of a lavatory of a bus. In some examples, indications and information based on the optical information obtained from an environment of a lavatory of a bus may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a bus may be provided to: the bus driver; one or more members of the bus maintenance team; security personnel; and so forth.

In some embodiments, optical information may be obtained from an environment of a lavatory of a train. In some examples, indications and information based on the optical information obtained from an environment of a lavatory of a train may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a train may be provided to: the train driver; one or more train conductors; one or more members of the train maintenance team; security personnel; and so forth.

In some embodiments, optical information may be obtained from an environment of a lavatory of a school. In some examples, indications and information based on the optical information obtained from an environment of a lavatory of a school may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a school may be provided to: one or more teachers; one or more members of the school maintenance team; one or more members of the school management team; security personnel; and so forth.

In some embodiments, optical information may be obtained from an environment of a lavatory of a healthcare facility. In some examples, indications and information based on the optical information obtained from an environment of a lavatory of a healthcare facility may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a healthcare facility may be provided to: one or more physicians; one or more nurses; one or more members of the healthcare facility maintenance team; one or more members of the healthcare facility management team; security personnel; and so forth.

In some embodiments, optical information may be obtained from an environment of a lavatory of a shop and/or a shopping center. In some examples, indications and information based on the optical information obtained from an environment of a lavatory of a shop and/or a shopping center may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a shop and/or a shopping center may be provided to: one or more salespersons; one or more members of the shop and/or the shopping center maintenance team; one or more members of the shop and/or the shopping center management team; security personnel; and so forth.

In some embodiments, optical information may be obtained from an environment of a lavatory of a bank and/or a financial institute. In some examples, indications and information based on the optical information obtained from an environment of a lavatory of a bank and/or a financial institute may be obtained, for example using: process 700; process 800; process 900; process 1000; process 1100; process 1200; process 1300; process 1400; process 1500; process 1600; process 1700; any combination of the above; and so forth. In some embodiments, the obtained indications and information based on the optical information obtained from an environment of a lavatory of a bank and/or a financial institute may be provided to: one or more bank tellers; one or more members of the bank and/or the financial institute maintenance team; one or more members of the bank and/or the financial institute management team; security personnel; and so forth.

In some examples, process 700 applied on optical information captured from environment 1801, environment 1802, environment 1901, or environment 1902 may provide an indication regarding the presence of the object 1830, while no such indication will be provided when applied on optical information captured from environment 1903 or environment 1904.

In some examples, process 900 applied on optical information captured from environment 1801 may inform that three persons are present. In case process 900 is configured to ignore people under certain age and/or under certain height, the process may ignore person 1822 and inform that two persons are present. Process 900 may also provide additional information, for example: that the three persons are one adult female, one adult male and one child; that one of the three persons holds an object; and so forth. In some examples, process 900 applied on optical information captured from environment 1802 may inform that three persons are present. In case process 900 is configured to ignore people under certain height, the process may ignore person 1823 and inform that two persons are present. Process 900 may also provide additional information, for example: that the three persons are one adult female and two adult males; that one of the three persons holds an object; and so forth. In some examples, process 900 applied on optical information captured from environment 1901 may inform that one person is present. Process 900 may also provide additional information, for example: that the one person present is an adult female; that the one person present holds an object; and so forth. In some examples, process 900 applied on optical information captured from environment 1903 may inform that one person is present. Process 900 may also provide additional information, for example: that the one person present is an adult female; and so forth. In some examples, process 900 applied on optical information captured from environment 1902 or environment 1904 may inform that no person is present.

In some examples, process 1000 applied on optical information captured from environment 1801 with a maximum threshold of three may provide an indication that the number of people equals or exceeds the maximal threshold. In case process 1000 is configured to ignore people under certain age and/or under certain height, such an indication will not be provided. In some examples, process 1000 applied on optical information captured from environment 1802 with a maximum threshold of three may provide an indication that the number of people equals or exceeds the maximal threshold. In case process 1000 is configured to ignore people under certain height, such an indication will not be provided. In some examples, process 1000 applied on optical information captured from environment 1901, environment 1902, environment 1903 or environment 1904 with a maximum threshold of two, will not provide an indication. In some examples, process 1000 applied on optical information captured from environment 1901 or environment 1903 with a maximum threshold of one, may provide an indication that the number of people equals or exceeds the maximal threshold, while no such indication will be provided when applied on 1902 or environment 1904 with a maximum threshold of one.

In some examples, process 1000 with a maximum threshold of one and when configured to consider only females and to ignore children, may provide an indication that the number of people equals or exceeds the maximal threshold when applied on optical information captured from environment 1801, environment 1802, environment 1901, or environment 1903; while no such indication will be provided when applied on optical information captured from environment 1902 or environment 1904.

In some examples, process 1000 with a maximum threshold of one and when configured to consider only males and to ignore children, may provide an indication that the number of people equals or exceeds the maximal threshold when applied on optical information captured from environment 1801 or environment 1802; while no such indication will be provided when applied on optical info nation captured from environment 1901, environment 1902, environment 1903 or environment 1904.

In some examples, process 1100 applied on optical information captured from environment 1902 or environment 1904 may provide an indication that no person is present, while no such indication will be provided when applied on optical information captured from environment 1801, environment 1802, environment 1901 or environment 1903.

In some examples, in a scenario where environment 1904 is followed by environment 1901, followed by environment 1902, applying process 1200 with optical information captured from environment 1904 as the first optical information and optical information captured from environment 1902 as the second optical information, may provide an indication regarding object 1830, while applying process 1300 with the same first optical information and second optical information will not provide indication regarding object 1830.

In some examples, in a scenario where environment 1902 is followed by environment 1901, followed by environment 1904, applying process 1300 with optical information captured from environment 1902 as the first optical information and optical information captured from environment 1904 as the second optical information, may provide an indication regarding object 1830, while applying process 1200 with the same first optical information and second optical information will not provide indication regarding object 1830.

In another example, in a scenario where environment 1904 is followed by environment 1901, followed by environment 1904, nor process 1200 neither process 1300 will provide indication regarding object 1830, as object 1830 is present only when a person is present.

In some embodiments, optical information may be obtained from an environment of a healthcare facility, such as a hospital, a clinic, a doctor's office, and so forth. For example, one or more optical sensors may be positioned within the healthcare facility. Examples of possible implementations of the optical sensors positioned within the healthcare facility include: image sensor 150; imaging apparatus 100; optical sensor 650; and so forth. Optical information may be captured by the optical sensors positioned within the healthcare facility. In some examples, the optical sensors positioned within the healthcare facility may be privacy preserving optical sensors. In some examples, the optical sensors positioned within the healthcare facility may be permanent privacy preserving optical sensors. In some cases, indications and information based on the optical information obtained from the environment of the healthcare facility may be obtained, for example using: process 700; process 800; process 900; process 1000; process 1100; process 1200; process 1300; process 1400; process 1500; process 1600; process 1700; any combination of the above; and so forth. In some cases, the obtained indications and information may be provided, for example in the fashion described above. In some embodiments, the indications and information may be provided to: a healthcare professional; a nursing station; the healthcare facility maintenance team; the healthcare facility security personnel; the healthcare facility management team; and so forth.

In some embodiments, at least one of the optical sensors positioned within the healthcare facility may be used to monitor a patient bed. In some cases, the optical information obtained from the environment of the healthcare facility may be monitor to identify a distress condition, for example using process 1600. Indication regarding the identification of the distress condition may be provided, for example in the fashion described above. In some cases, the optical information obtained from the environment of the healthcare facility may be monitor to identify a patient falling off the patient bed, for example using process 1600. Indication regarding the identification of the patient falling off the patient bed may be provided, for example in the fashion described above. In some cases, the optical information obtained from the environment of the healthcare facility may be monitor to identify an inappropriate act of a sexual nature, for example using process 1700. Indication regarding the identification of the inappropriate act of a sexual nature may be provided, for example in the fashion described above. In some cases, optical information obtained from the environment of the healthcare facility may be monitored to identify cases where two or more people are within a single patient bed, for example using process 1000, using process 800, and so forth. Indication regarding the identification of a case where two or more people are within a single patient bed may be provided, for example in the fashion described above. In some cases, optical information obtained from the environment of the healthcare facility may be monitored to identify cases where maintenance is required, for example using a process similar to process 1400. Indication regarding the identification of a case where maintenance is required may be provided, for example in the fashion described above. In some cases, optical information obtained from the environment of the healthcare facility may be monitored to identify a patient vomiting, for example using process 800. Indication regarding the identification of the vomiting patient may be provided, for example in the fashion described above. In some cases, optical information obtained from the environment of the healthcare facility may be monitored to identify smoke and/or fire, for example using process 1500. Indication regarding the identification of the smoke and/or fire may be provided, for example in the fashion described above.

In some embodiments, optical information may be obtained from an environment of a dressing room. For example, one or more optical sensors may be positioned within and/or around the dressing room. Examples of possible implementations of the optical sensors positioned within and/or around the dressing room include: image sensor 150; imaging apparatus 100; optical sensor 650; and so forth. Optical information may be captured by the optical sensors positioned within and/or around the dressing room. In some examples, the optical sensors positioned within and/or around the dressing room may be privacy preserving optical sensors. In some examples, the optical sensors positioned within and/or around the dressing room may be permanent privacy preserving optical sensors. In some cases, indications and information based on the optical information obtained from the environment of the dressing room may be obtained, for example using: process 700; process 800; process 900; process 1000; process 1100; process 1200; process 1300; process 1400; process 1500; process 1600; process 1700; any combination of the above; and so forth. In some cases, the indications and information may be provided, for example in the fashion described above. In some embodiments, the indications and information may be provided to: a sales person; a shop assistant; the shop maintenance team; the shop security personnel; the shop management team; and so forth.

In some embodiments, at least one of the optical sensors positioned within and/or around the dressing room may be used to detect shoplifters, for example using a face recognition algorithm used with a database of known shoplifters. Indication regarding the detection of the shoplifter may be provided, for example in the fashion described above. In some embodiments, at least one of the optical sensors positioned within and/or around the dressing room may be used to detect shoplifting events, for example using process 800. Indication regarding the detection of the shoplifting event may be provided, for example in the fashion described above. In some embodiments, at least one of the optical sensors positioned within and/or around the dressing room may be used to detect acts of vandalism, such as the destruction of one or more of the store products, one or more clothing items, and so forth. One possible implementation is using process 800 to detect acts of vandalism. Indication regarding the detection of the act of vandalism may be provided, for example in the fashion described above.

In some embodiments, optical information may be obtained from an environment of a mobile robot. For example, one or more optical sensors may be mounted to the mobile robot. Examples of possible implementations of the mounted optical sensors include: image sensor 150; imaging apparatus 100; optical sensor 650; and so forth. Optical information may be captured by the mounted optical sensor. In some examples, the mounted optical sensor may be a privacy preserving optical sensor. In some examples, the mounted optical sensor may be a permanent privacy preserving optical sensor. In some cases, indications and information based on the optical information obtained from the environment of the mobile robot may be obtained, for example using: process 700; process 800; process 900; process 1000; process 1100; process 1200; process 1300; any combination of the above; and so forth. In some cases, egomotion may be estimated based on the optical information. In some cases, motion of objects in the environment of the mobile robot may be estimated based on the optical information. In some cases, the position of objects in the environment of the mobile robot may be estimated based on the optical information. In some cases, the topography of the environment of the mobile robot may be estimated based on the optical information. In some cases, navigation decisions may be made based on the optical information.

In some embodiments, an operation mode of an apparatus may be changed based on optical information captured by a privacy preserving optical sensor. In some cases, the operation mode of an apparatus may be changed from a sleep mode to an active mode or vice versa. For example, the operation mode of the apparatus may be changed to an active mode when: a user is present in the field of view of the privacy preserving optical sensor; a user is present in the field of view of the privacy preserving optical sensor for a time duration that exceeds a specified threshold; a user is facing the apparatus; and so forth. In some cases, the optical information may be monitored to identify a condition, and the operation mode of the apparatus may be changed when the condition is identified. In some examples, the condition may be identified using at least one of: determining if an item is present (Step 720); determining if an event occurred (Step 820); determining if the number of people equals or exceeds a maximum threshold (Step 1020); determining if no person is present (Step 1120); determining if an object is not present and no person is present (Step 1220); determining if an object is present and no person is present (Step 1240); determining if a lavatory requires maintenance (Step 1420); detecting smoke and/or fire (Step 1520); detecting one or more persons (Step 1620); detecting a distress condition (Step 1630); detecting a sexual harassment and/or a sexual assault (Step 1730); any combination of the above; and so forth. In some examples, identifying the condition may be based on one or more decision rules. For example, the one or more decision rules may be stored in a memory unit, such as the one or more memory units 110, and the one or more decision rules may be obtained by accessing the memory unit and reading the rules. For example, at least one of the one or more decision rules may be preprogrammed manually. In another example, at least one of the one or more decision rules may be the result of training machine learning algorithms on training examples. The training examples may include examples of optical information instances. In an additional example, at least one of the one or more decision rules may be the result of deep learning algorithms. In another example, at least one of the one or more decision rules may be based, at least in part, on the output of one or more neural networks, such as the output obtained by applying the one or more neural networks on the optical information. It will also be understood that the system according to the invention may be a suitably programmed computer, the computer including at least a processing unit and a memory unit. For example, the computer program can be loaded onto the memory unit and can be executed by the processing unit. Likewise, the invention contemplates a computer program being readable by a computer for executing the method of the invention. The invention further contemplates a machine-readable memory tangibly embodying a program of instructions executable by the machine for executing the method of the invention.

What is claimed is:

1. A system for monitoring lavatories, comprising:
at least one optical sensor configured to capture optical information from an environment; and
at least one processing module configured to:
monitor the optical information to determine that a number of people present in the environment equals or exceeds a maximum threshold; and
provide an indication to a user based on the determination that the number of people present in the environment equals or exceeds the maximum threshold.

2. The system of claim 1, wherein the maximum threshold is one person.

3. The system of claim 1, wherein the maximum threshold is two people.

4. The system of claim 1, wherein the maximum threshold is at least three people.

5. The system of claim 1, wherein the at least one optical sensor is one optical sensor.

6. The system of claim 1, wherein the at least one optical sensor is two optical sensors.

7. The system of claim 1, wherein the at least one optical sensor is at least three optical sensors.

8. The system of claim 1, designed to monitor lavatories in an airplane, and wherein the user is a member of an aircrew.

9. The system of claim 1, designed to monitor lavatories in a bus, and wherein the user is a bus driver.

10. The system of claim 1, wherein the at least one processing module is further configured to ignore people under a certain age in the determination that the number of people present in the environment equals or exceeds the maximum threshold.

11. The system of claim 1, wherein the at least one processing module is further configured to ignore people under a certain height in the determination that the number of people present in the environment equals or exceeds the maximum threshold.

12. The system of claim 1, wherein at least one of the at least one optical sensor is an image sensor.

13. The system of claim 1, wherein at least one of the at least one optical sensor is a privacy preserving optical sensor.

14. The system of claim 13, wherein the privacy preserving optical sensor is a permanent privacy preserving optical sensor.

15. The system of claim 1, wherein the at least one processing module is further configured to:
process the optical information using one or more neural networks to obtain output of the one or more neural networks; and
base the determination that the number of people present in the environment equals or exceeds the maximum threshold on the output of the one or more neural networks.

16. The system of claim 1, wherein the determination that the number of people present in the environment equals or exceeds the maximum threshold is based on a decision rule; and wherein the decision rule is a result of training one or more machine learning algorithms on training examples.

17. The system of claim 1, wherein the at least one processing module is further configured to:
determine a number of people present in the environment based on the optical information, therefore obtaining an estimated number of people; and
provide to the user information associated with the estimated number of people.

18. The system of claim 17, wherein the determination of the number of people present in the environment is based on a regression model; and wherein the regression model is a result of training one or more machine learning algorithms on training examples.

19. The system of claim 1, wherein the at least one processing module is further configured to:
monitor the optical information to determine that there are no people present in the environment; and
provide an indication to the user based on the determination that there are no people present in the environment.

20. The system of claim 1, wherein the at least one processing module is further configured to:
monitor the optical information to detect a presence of one or more objects of one or more specified categories of objects; and
provide an indication to the user based on the detection of the presence of the one or more objects.

21. The system of claim 20, wherein at least one category of the one or more specified categories of objects is a category of weapon objects.

22. The system of claim 1, wherein the at least one processing module is further configured to:
monitor the optical information to detect that at a first point in time an object is not present and no person is present;
monitor the optical information to detect that at a second point in time the object is present and no person is present, the second point in time being subsequent to the first point in time; and
provide an indication to the user based on the detection that at the first point in time the object is not present and no person is present and on the detection that at the second point in time the object is present and no person is present.

23. The system of claim 1, wherein the at least one processing module is further configured to:
monitor the optical information to detect that at a first point in time an object is present and no person is present;
monitor the optical information to detect that at a second point in time the object is not present and no person is present, the second point in time being subsequent to the first point in time; and
provide an indication to the user based on the detection that at the first point in time the object is present and no person is present and on the detection that at the second point in time the object is not present and no person is present.

24. The system of claim 1, wherein the at least one processing module is further configured to:
monitor the optical information to determine that a lavatory requires maintenance; and
provide an indication to the user based on the determination that the lavatory requires maintenance.

25. The system of claim 24, wherein the at least one processing module is further configured to monitor the optical information to detect a malfunction; and wherein the determination that the lavatory requires maintenance is based on the detection of the malfunction.

26. The system of claim 25, wherein the malfunction is at least one of: a flooding lavatory, a water leak, a malfunctioning light bulb, and a malfunction in the lavatory flushing system.

27. The system of claim 24, wherein the at least one processing module is further configured to monitor the optical information to determine that the lavatory requires cleaning; and wherein the determination that the lavatory requires maintenance is based on the determination that the lavatory requires cleaning.

28. The system of claim 24, wherein the at least one processing module is further configured to monitor the optical information to determine that equipment in the lavatory is physically broken; and wherein the determination that the lavatory requires maintenance is based on the determination that the equipment in the lavatory is physically broken.

29. The system of claim 24, wherein the at least one processing module is further configured to monitor the optical information to detect an undesired painting; and wherein the determination that the lavatory requires maintenance is based on the detection of the undesired painting.

30. The system of claim 1, wherein the at least one processing module is further configured to:
monitor the optical information to determine that at least one person in the environment performed one or more actions of a list of specified actions; and
provide an indication to the user based on the determination that the at least one person performed the one or more actions.

31. The system of claim 30, wherein the list of specified actions comprises at least one of: painting, smoking, igniting fire, and breaking an object.

32. The system of claim 1, wherein the at least one processing module is further configured to:
monitor the optical information to detect the presence of at least one of: smoke in the environment, and fire in the environment; and
provide an indication to the user based on the detection of the presence of at least one of: smoke in the environment, and fire in the environment.

33. A method for monitoring lavatories, comprising:
receiving optical information captured by at least one optical sensor from an environment;
monitoring the optical information to determine that a number of people present in the environment equals or exceeds a maximum threshold; and
providing an indication to the user based on the determination that the number of people present in the environment equals or exceeds the maximum threshold.

34. The method of claim 33, wherein the maximum threshold is one person.

35. The method of claim 33, wherein the maximum threshold is two people.

36. The method of claim 33, wherein the maximum threshold is at least three people.

37. The method of claim 33, wherein the at least one optical sensor is one optical sensor.

38. The method of claim 33, wherein the at least one optical sensor is two optical sensors.

39. The method of claim 33, wherein the at least one optical sensor is at least three optical sensors.

40. The method of claim 33, wherein the user is at least one of: a member of an aircrew, and a bus driver.

41. The method of claim 33, wherein people under a certain age are ignored in the determination that the number of people present in the environment equals or exceeds the maximum threshold.

42. The method of claim 33, wherein people under a certain height are ignored in the determination that the number of people present in the environment equals or exceeds the maximum threshold.

43. The method of claim 33, wherein at least one of the at least one optical sensor is an image sensor.

44. The method of claim 33, wherein at least one of the at least one optical sensor is a privacy preserving optical sensor.

45. The method of claim 44, wherein the privacy preserving optical sensor is a permanent privacy preserving optical sensor.

46. The method of claim 33, further comprising:
processing the optical information using one or more neural networks to obtain output of the one or more neural networks; and
base the determination that the number of people present in the environment equals or exceeds the maximum threshold on the output of the one or more neural networks.

47. The method of claim 33, wherein the determination that the number of people present in the environment equals or exceeds the maximum threshold is based on a decision rule; and wherein the decision rule is a result of training one or more machine learning algorithms on training examples.

48. The method of claim 33, further comprising:
determining a number of people present in the environment based on the optical information, therefore obtaining an estimated number of people; and
providing to the user information associated with the estimated number of people.

49. The method of claim 48, wherein the determination of the number of people present in the environment is based on a regression model; and wherein the regression model is a result of training one or more machine learning algorithms on training examples.

50. The method of claim 33, further comprising:
monitoring the optical information to determine that there are no people present in the environment; and
providing an indication to the user based on the determination that there are no people present in the environment.

51. The method of claim 33, further comprising:
monitoring the optical information to detect a presence of one or more objects of one or more specified categories of objects; and
providing an indication to the user based on the detection of the presence of the one or more objects of the one or more specified categories of objects.

52. The method of claim 51, wherein at least one category of the one or more specified categories of objects is a category of weapon objects.

53. The method of claim 33, further comprising:
monitoring the optical information to detect that at a first point in time an object is not present and no person is present;
monitoring the optical information to detect that at a second point in time the object is present and no person is present, the second point in time being subsequent to the first point in time; and
providing an indication to the user based on the detection that at the first point in time the object is not present and no person is present and on the detection that at the second point in time the object is present and no person is present.

54. The method of claim 33, further comprising:
monitoring the optical information to detect that at a first point in time an object is present and no person is present;
monitoring the optical information to detect that at a second point in time the object is not present and no person is present, the second point in time being subsequent to the first point in time; and
providing an indication to the user based on the detection that at the first point in time the object is present and no person is present and on the detection that at the second point in time the object is not present and no person is present.

55. The method of claim 33, further comprising:
monitoring the optical information to determine that a lavatory requires maintenance; and
providing an indication to the user based on the determination that the lavatory requires maintenance.

56. The method of claim 55, further comprising:
monitoring the optical information to detect a malfunction;
and wherein the determination that the lavatory requires maintenance is based on the detection of the malfunction.

57. The method of claim 56, wherein the malfunction is at least one of: a flooding lavatory, a water leak, a malfunctioning light bulb, and a malfunction in the lavatory flushing system.

58. The method of claim 55, further comprising:
monitoring the optical information to determine that the lavatory requires cleaning;
and wherein the determination that the lavatory requires maintenance is based on the determination that the lavatory requires cleaning.

59. The method of claim 55, further comprising:
monitoring the optical information to determine that equipment in the lavatory is physically broken;
and wherein the determination that the lavatory requires maintenance is based on the determination that the equipment in the lavatory is physically broken.

60. The method of claim 55, further comprising:
monitoring the optical information to detect an undesired painting;
and wherein the determination that the lavatory requires maintenance is based on the detection of the undesired painting.

61. The method of claim 33, further comprising:
monitoring the optical information to determine that at least one person in the environment performed one or more actions of a list of specified actions; and
providing an indication to the user based on the determination that the at least one person performed the one or more actions.

62. The method of claim 61, wherein the list of specified actions comprises at least one of: painting, smoking, igniting fire, and breaking an object.

63. The method of claim 33, further comprising:
monitoring the optical information to detect the presence of at least one of: smoke in the environment, and fire in the environment; and
providing an indication to the user based on the detection of the presence of at least one of smoke in the environment, and fire in the environment.

64. A software product stored on a non-transitory computer readable medium and comprising data and computer implementable instructions for carrying out the method of claim 33.
